(19) United States
(12) Patent Application Publication
(10) Pub. No.: US 2011/0016109 A1
(43) Pub. Date: Jan. 20, 2011

(54) System and Method for Automatic Matching of Highest Scoring Contracts to Impression Opportunities Using Complex Predicates and an Inverted Index

(76) Inventors: Sergei Vassilvitskii, New York, NY (US); Ramana Yerneni, Cupertino, CA (US); Javavel Shanmugasundaram, Santa Clara, CA (US); Erik Vee, San Mateo, CA (US); Chad Brower, San Jose, CA (US); Steven Whang, Stanford, CA (US)

Correspondence Address: Stattler-Suh PC, 60 SOUTH MARKET, SUITE 480, SAN JOSE, CA, 95113, US

(21) Appl. No.: 12/502,742

(22) Filed: Jul. 14, 2009

(51) Int. Cl. G06F 17/30; G06Q 30/00; G06Q 10/00

(52) U.S. Cl. 707/723; 705/14.73; 707/E17.084

(57) ABSTRACT

A method for indexing advertising contracts for rapid retrieval and matching in order to match only the top N satisfying contracts to advertising slots. Descriptions of advertising contracts include logical predicates indicating weighted applicability to a particular demographic. Descriptions of advertising slots also contain logical predicates indicating weighted applicability to particular demographics, thus matches are performed on the basis of a weighed score of intersecting demographics. Disclosed are structure and techniques for receiving a set of contracts with weighted predicates, preparing a data structure index of the set of contracts, receiving an advertising slot with weighted predicates, and retrieving from the data structure only the top N weighted score contracts that satisfy a match to the advertising slot predicates. Various disclosed cases include predicates presented in conjoint forms and in disjoint forms, and techniques are provided to consider indexing and matching in cases of both IN predicates and NOT-IN predicates.

### FIELD OF THE INVENTION

The present invention is directed towards management of on-line advertising contracts based on targeting.

### BACKGROUND OF THE INVENTION

The marketing of products and services online over the Internet through advertisements is big business. Advertising over the Internet seeks to reach individuals within a target set having very specific demographics (e.g. male, age 40-48, graduate of Stanford, living in California or New York, etc). This targeting of very specific demographics is in significant contrast to print and television advertisement that is generally capable only to reach an audience within some broad, general demographics (e.g. living in the vicinity of Los Angeles, or living in the vicinity of New York City, etc). The single appearance of an advertisement on a webpage is known as an online advertisement impression. Each time a web page is requested by a user via the Internet, represents an impression opportunity to display an advertisement in some portion of the web page to the individual Internet user. Often, there may be significant competition among advertisers for a particular impression opportunity to be the one to provide that advertisement impression to the individual Internet user.

To participate in this competition, some advertisers enter into contracts with an ad serving company (or publisher) to receive impressions over a desired time period. An advertiser may further specify desired targeting criteria. For example, an advertiser and the ad serving company may agree to post 2,000,000 impressions over thirty days for US$15,000. Others merely enter into non-guaranteed contracts with the ad server company and only pay for those impressions actually made by the ad serving company on their behalf. Of course, in modern Internet advertising systems, the competition among advertisers is often resolved by an auction, and the winning bidder's advertisements are shown in the available spaces of the impression.

Indeed online advertising and marketing campaigns often rely at least partially on an auction process where any number of advertisers book contracts to submit and authorize highest bids corresponding to the contract characteristics (e.g. keywords, or bid phrases or various demographics). In some cases the number of contracts that could satisfy some particular targeting criteria (e.g. male, age 40-48, graduate of Stanford, living in California or New York, etc), might be a large number. In order to limit the number of contracts that are subjected to the auction process, only the most likely candidate contracts are sent to auction. The advertisements corresponding to the winning contracts are used for presenting the impression.

Considering that (1) the actual existence of a web page impression opportunity suited for displaying an advertisement is not known until the user clicks on a link pointing to the subject web page, and (2) that the bidding process for selecting advertisements must complete before the web page is actually displayed, it then becomes clear that the process of assembling competing contracts, completing the bidding, and compositing the web page with the winner's ads must start and complete within a matter of fractions of a second. Thus, a system that rapidly matches contracts to opportunities for the purpose of optimizing the allocation of online advertising is needed.

Other automated features and advantages of the present invention will be apparent from the accompanying drawings, and from the detailed description that follows below.

### SUMMARY OF THE INVENTION

A method for indexing advertising contracts for rapid retrieval and matching in order to match only the top N satisfying contracts to advertising slots. Descriptions of advertising contracts include logical predicates indicating weighted applicability to a particular demographic. Descriptions of advertising slots also contain logical predicates indicating weighted applicability to a particular demographic, thus matches are performed on the basis of a weighed score of intersecting demographics. Disclosed are structure and techniques for receiving a set of contracts with weighted predicates, preparing a data structure index of the set of contracts, receiving an advertising slot with weighted predicates, and retrieving from the data structure only the top N weighted score contracts that satisfy a match to the advertising slot predicates. Various disclosed cases include predicates presented in conjoint forms and in disjoint forms, and techniques are provided to consider indexing and matching in cases of both IN predicates and NOT-IN predicates.

### BRIEF DESCRIPTION OF THE DRAWINGS

The novel features of the invention are set forth in the appended claims. However, for purpose of explanation, several embodiments of the invention are set forth in the following figures.

FIG. 1A shows an ad network environment in which some embodiments operate.

FIG. 1B shows an ad network environment including an auction engine server in which some embodiments operate.

FIG. 2A is a depiction of a two-dimensional table of inventory, according to according to one embodiment.

FIG. 2B is a depiction of a three-dimensional table of inventory, according to according to one embodiment.

FIG. 3 is a depiction of a system for serving advertisements within which some embodiments may be practiced.

FIG. 4 is a depiction of a modularized environment including delivering a set of contracts within which some embodiments may be practiced.

FIG. 5 is a depiction of a modularized environment including constructing an inverted index within which some embodiments may be practiced.

FIG. 6 is a diagrammatic representation of a machine in the exemplary form of a computer system, within which a set of instructions may be executed, according to according to one embodiment.

FIG. 7 is a diagrammatic representation of several computer systems in the exemplary environment of a client server network, within which environment a communication protocol may be executed, according to one embodiment.

### DETAILED DESCRIPTION

In the following description, numerous details are set forth for purpose of explanation. However, one of ordinary skill in the art will realize that the invention may be practiced without the use of these specific details. In other instances, well-known structures and devices are shown in block diagram form in order to not to obscure the description of the invention with unnecessary detail.

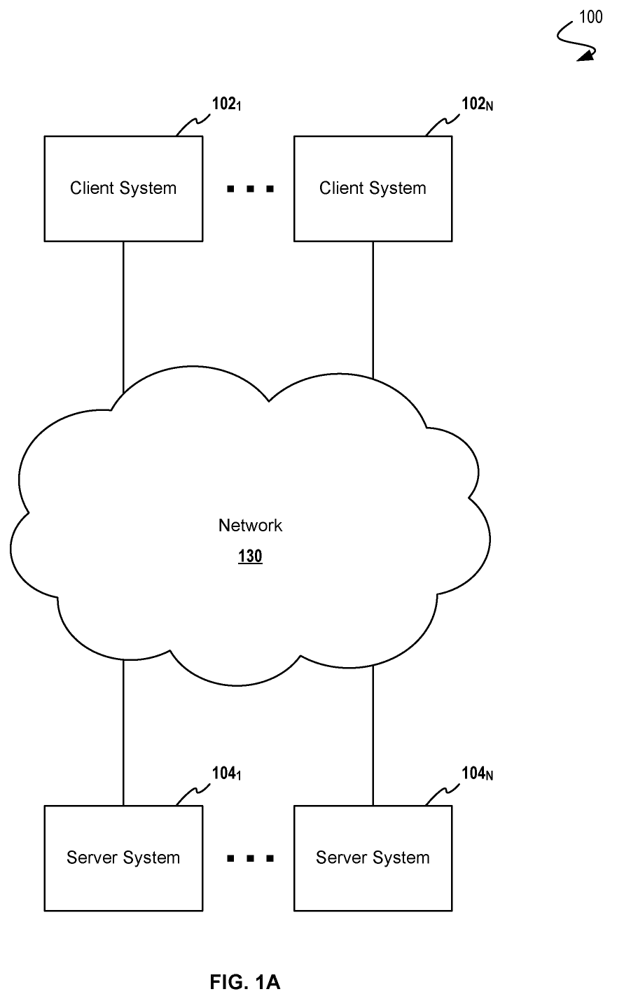

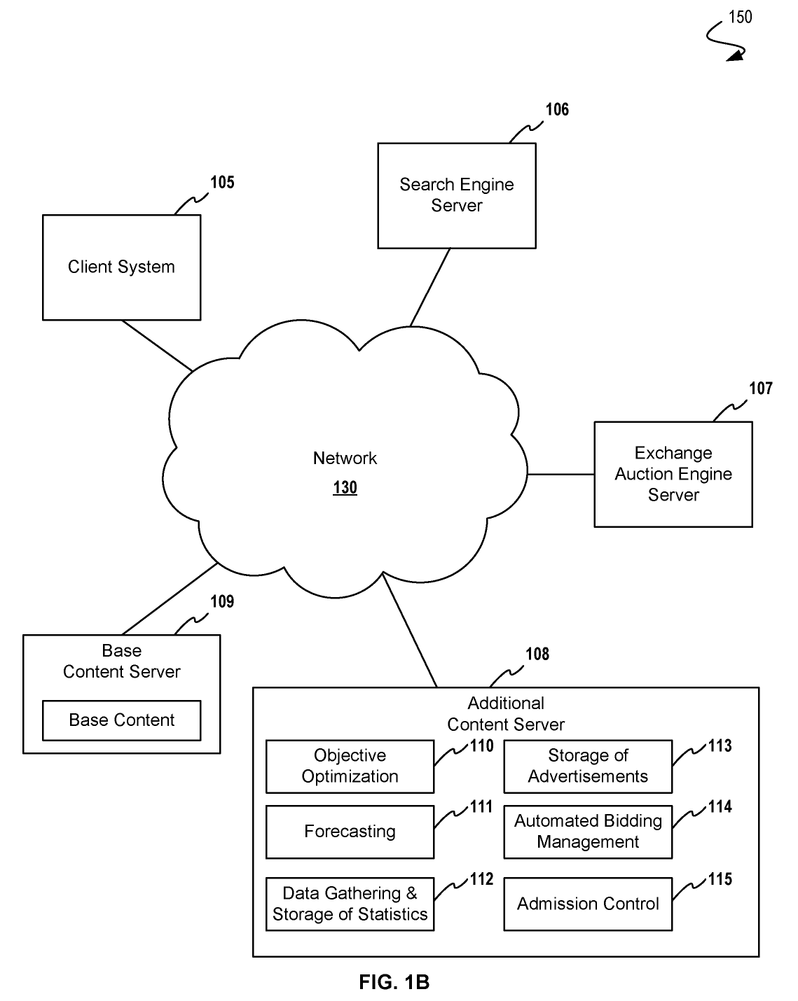

In the context of Internet advertising, bidding for placement of advertisements within an Internet environment (e.g. system 100 of FIG. 1A) has become common. By way of a simplified description, an Internet Advertiser may select a particular property (e.g. the landing page for the Empire State, empirestate.com), and may create an advertisement such that whenever any Internet user, via a client system 102₁-102_{N} renders the web page from empirestate.com, the advertisement is composited on a web page by a server 104₁-104_{N} for delivery to a client system 102 over a network 130. This model works well for property-oriented advertising: The number of visits to such property's web pages (i.e. number of hits in a time period) is easy to capture over time, and thus, a history of visits is a good estimate of the number of visits one could expect in the near future, and thus a recent history of web page visits is a good predictor of some future number of hits. This is analogous to print media in that an advertiser noting that the previous month had a readership of 10,000 would reasonably expect roughly 10,000 readers in the following month. Neither of these models, as described, takes into account any specific demographics.

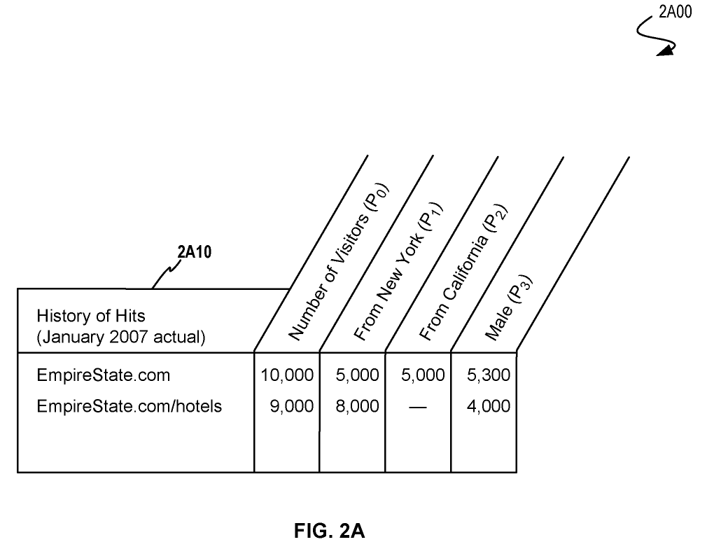

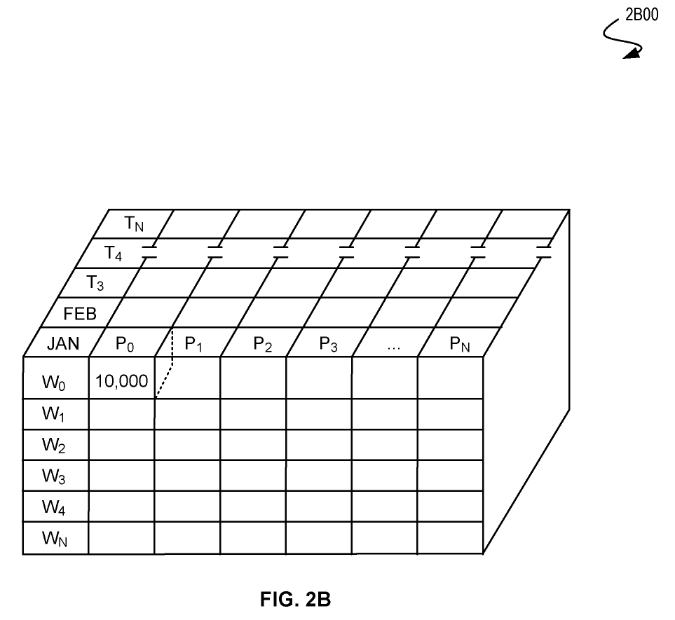

In the slightly more sophisticated model of FIG. 1B, referring to system 150, and considering only Internet advertising, an Internet property (e.g. empirestate.com) hosted on a content server 109, might measure 10,000 hits in a given month. It also might be able to measure that of those 10,000 hits, 5000 of those hits originated from client systems 105 located in California. It might further be able to measure that of the 10,000 hits from California, 5300 of those were from individuals who identified themselves as male. Still further, the Internet property might be able to measure the number of visitor to empirestate.com who traversed to a sub-page, say empirestate.com/hotels or the Internet property might be able to measure the number of visitors that arrived at the empirestate.com domain based on a referral from a search engine server 106. Still further, an Internet property might be able to measure the number of visitors that have any arbitrary characteristic, demographic or attribute, possibly using an additional content server 108, in conjunction with a data gathering or statistics operation 112. Thus, an Internet user might be ‘known’ in quite some detail as pertains to a wide range of demographics or other attributes. As shown in FIG. 2A, a table of inventory 2A10 can be constructed showing a variety of demographics. For example, a history of hits and other analytics (i.e. actual hits as measured) might indicate how many hits occurred in a particular month (e.g. January 2007) at a particular page (e.g. empirestate.com had 10,000 visitors) or sub-page (e.g. empirestate.com/hotels had 9,000 visitors). And to the extent that any particular demographics can be captured (e.g. visitors from New York, visitors from California, male visitors, etc) those counts might also be captured and used in predicting inventory for an upcoming time period. As shown, FIG. 2A depicts page hits for just one month (e.g. January, 2007), however any number of time periods might be represented in a three dimensional table.

FIG. 2B depicts a three dimensional table 2B00 showing dimensions of web site page (e.g. W₀, W₁, W₂, Wₙ), time period (e.g. T₀, T₁, T₂, Tₙ), and some selection of demographic properties (e.g. P₀, P₁, P₂, Pₙ). As shown, there were 10,000 hits in January at web page W₀ corresponding to the property P₀. In the context of demographics available for various populations, FIG. 2B is a trivial example in only three dimensions. Typically, many more dimensions are available, and might be represented in an N-space array (i.e. high-dimensional space). Of course any M-dimensional array where M is greater than three is difficult to show on paper. However alternative representations such as an M-dimensional array (where M is any positive integer) and methods for identifying sets of points (e.g. showing conjoint or disjoint, or overlapping sets), or lists of attribute/value pairs (e.g. {state, California}, {gender, male}, {age, 45}, {weight, 165}) might be used to represent points in M-dimensional space.

Given any of such representations of a point in M-dimensional space, any degree of M can be captured over time, and such a capture (e.g. a history) might be used in predicting future events. A finer degree of specificity is useful in targeted advertising. For example, an advertiser for a hotel in mid-town New York City might want to place advertisements only on the empirestate.com/hotels web page as shown to an Internet user, and then only if the Internet user is from California, and then only if the Internet user is male, and so on. Such an advertiser might be willing to pay a premium for a spot that is most prominently located on the web page. In fact, such an advertiser might be joined by other hoteliers who also want their advertisements to be displayed in the most prominently located spot on the web page. However, the inventory for that one web page impression being displayed to that particular user at that point in time is of course limited to just that one impression. Thus, multiple competing advertisers might elect to bid in a market (e.g. an exchange) via an exchange server or auction engine 107 in order to win the most prominent spot, or an advertiser might enter into a contract (e.g. with the Internet property or with an advertising agency, or with an advertising network, etc) to purchase in advance all of the desired spots for some time duration (e.g. all top spots in all impressions of the web page empirestate.com/hotels for all of 2008). Such an arrangement and variants as used here is termed a contract. A contract might be as simple as the one in the previous example, or a contract might be more complex, possibly involving many attribute, value pairs to describe a target. Alternatively, the advertiser might not enter into such a pre-arranged placement contract (also known as guaranteed delivery), and instead might decide to allow impressions to be made over time, on the fly, when the advertiser's bid is the winning bid (also known as non-guaranteed delivery). In some embodiments, the system 150 might host a variety of modules to serve management and control operations (e.g. forecasting 111, admission control 115, automated bidding management 114, objective optimization 110, etc) and storage functions (e.g. storage of advertisements 113, storage of statistics 112, etc) pertinent to both guaranteed delivery as well as non-guaranteed delivery methods. Of course there are many differences and many implications in the set-up and operation of guaranteed delivery versus non-guaranteed delivery, some of which are described below.

### Section I: General Terms and Network Environment

In most cases, the set-up and operational differences between guaranteed delivery model versus non-guaranteed delivery model creates artificial distinctions between these two models. In particular, pricing of display inventory that is priced at fixed contract prices (e.g. guaranteed delivery contracts), and pricing of inventory that is priced in a real-time auction in a spot market or through other means (non-guaranteed delivery) may differ significantly. In some cases the fixed contract price of an impression is lower than the true market value of the impression (e.g. if the fixed price contract covered some exceptionally high traffic period). In some cases, the reverse is true. Additional artificial distinctions between these two models cause difficult-to-price differences, for instance, some ad network systems always serve guaranteed contracts their quota before serving non-guaranteed contracts. This mode can result in the phenomenon of high-quality impressions to be mostly served to guaranteed contracts.

In some markets, however, advertisers demand a mix of guaranteed and non-guaranteed contracts. This creates a need for a unified marketplace whereby an impression opportunity can be allocated to a guaranteed or non-guaranteed contract based on the value of the impression opportunity to the different contracts. Such a unified marketplace enables a more equitable allocation of inventory, and also promotes increased competition between guaranteed and non-guaranteed contracts.

What is needed are techniques that enables guaranteed contracts to bid on the spot-market for each impression opportunity and thus compete directly with non-guaranteed contracts. The need is intensified the more that display advertising increases in refinement of the target. Indeed increased targeting allows advertisers to reach more relevant customers. For example, an advertiser selling family fitness aids might specify a target using broad targeting constraints such as “1 million Yahoo! users from 1 Aug. 2008-31 Aug. 2008”. In contrast, an advertiser selling fitness aids for surfers might specify a much more fine-grained constraint such as “10,000 Yahoo! users from 1 Aug. 2008-8 Aug. 2008 who are California males between the ages of 20-35 who are working in the healthcare industry and like surfing and autos”. Fine-grained targeting has implications to the aforementioned techniques. First, there is the need to forecast future inventory for fine-grained targeted combinations. Second, there is the need to manage contention in a high-dimensional targeting space. That is, given hundreds (or thousands, or more) distinct targeting attributes it is reasonable that different advertisers might specify different high-dimensioned targets, and further that multiple advertisers might specify overlapping targeting combinations. Thus there is a need to accurately forecast inventory of targeted impression opportunities such that the union of all guaranteed contracts do not substantially over subscribe the available impression opportunities. Resolving to a statistically reliable forecast of inventory (e.g. a plan) might be supported in part by historical statistics and heuristics.

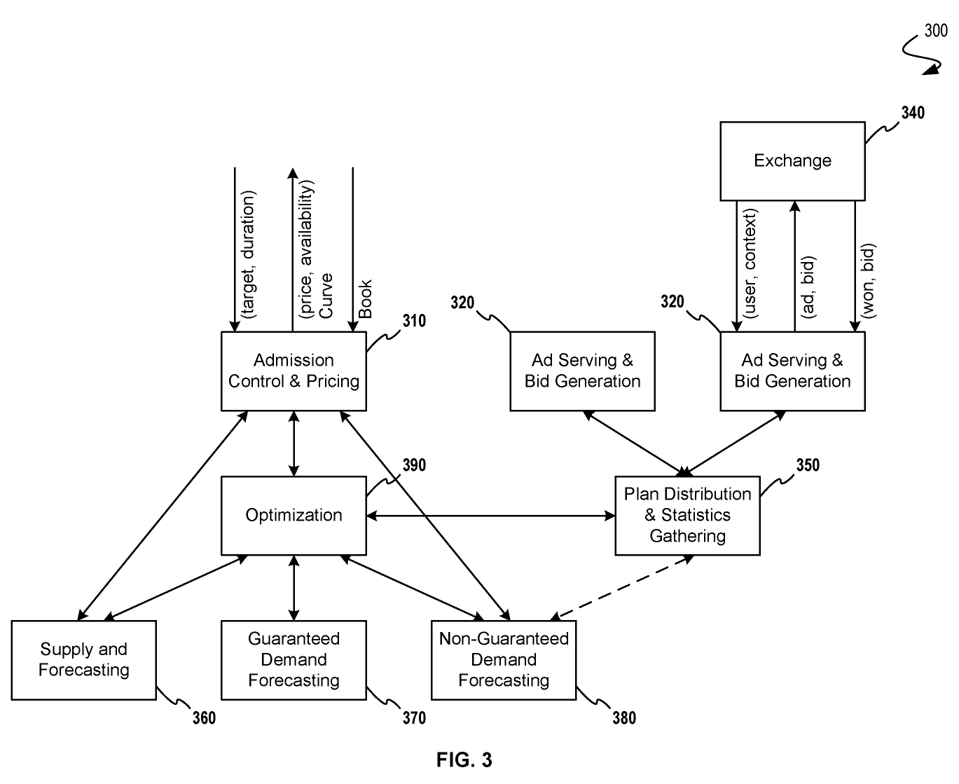

FIG. 3 depicts a system 300 in which embodiments of the invention might be practiced. As depicted, a system of components cooperatively communicate such that various overall objectives might be met. For example, an objective stated as “optimize guaranteed delivery revenue” might employ a module to coordinate the data exchange and execution of various system components, including (for example) an admission control module 310, an ad serving and bid generation module 320, an exchange module 340, a plan distribution module 350, a supply and forecasting module 360, a guaranteed demand forecasting module 370, a non-guaranteed demand forecasting module 380, and an optimization module 390.

Given such an environment the admission control portion of module 310 serves to generate quotes for guaranteed contracts and accept bookings of guaranteed contracts, the pricing portion of module 310 serves to price guaranteed contracts, the ad serving portion of module 320 selects guaranteed ads for an incoming opportunity, the bidding portion of module 320 submits bids for the selected guaranteed ads on an exchange 340. Additionally, an optimizer 390 might communicate with a plan distribution and statistics gathering module 350, and one or more forecasting modules 360, 370, 380 and return results that optimizes for an overall objective.

Given the system 300 of FIG. 3, a possible operational scenario might proceed as follows:

The admission control module supports queries and other interactions with sales personnel who quote guaranteed contracts to advertisers, and book the resulting contracts. A sales person issues a query with a specified target (e.g. “100,000 Yahoo! users from 1 Aug. 2008-8 Aug. 2008 who are California males between the ages of 20-35 who are working in the healthcare industry and like surfing and autos”). The admission control module 310 returns the available inventory for the target and returns the associated price for the available inventory. The sales person can then book corresponding contracts accordingly. The ad server module 320 takes in an opportunity (e.g. an impression opportunity), and returns an ad corresponding to the opportunity along with the amount that the system is willing to bid for that opportunity in the spot market (the Exchange).

In one embodiment, the operation of the entire system 300 is orchestrated by an optimization module 390. This optimization module 390 periodically takes in a forecast of supply (future impression opportunities), guaranteed demand (expected guaranteed contracts) and non-guaranteed demand (expected bids in the spot market) and matches supply to demand using an overall objective function. The optimization module then sends a plan of the optimization result to the admission control and pricing module 310. Of course, inasmuch as the plan is based on statistics relating to data gathered over time, the plan is updated every few hours based on new estimates for supply, new estimates demand, and new estimates for deliverable impressions.

In another scenario, and one that relates to techniques for finding all applicable contracts (i.e. guaranteed as well as non-guaranteed contracts), and bringing their respective bids to the unified marketplace might operate in a scenario described as follows:

When a sales person issues a query (to the admission control and pricing module 310) for some contract (e.g. including a target specification and duration) for future delivery (i.e. guaranteed or non-guaranteed), the system 300 invokes the supply forecasting module 360 to identify how much inventory is available for that contract. Since targeting queries can be very fine-grained in a high-dimensional space, the supply forecasting module might employ a scalable multi-dimensional database indexing technique to capture and store the correlations between different targeting attributes. The scalable multi-dimensional database indexing technique might also serve to capture and retrieve correlations found among multiple contracts. For example, if there are two sales persons submitting contracts in contention (e.g. “Yahoo! finance users who are California males” and “Yahoo! users who are aged 20-35 and interested in sports”), some number of forecasted impression opportunities might match both contracts, but of course the inventory of matching impression opportunities should not be double-counted. In order to deal with contract contention for supply in a high-dimensional space, the supply forecasting system might produce impression samples (i.e. a selected subset of the total available inventory) as opposed to just available inventory counts. Thus, impression opportunity samples from available inventory might be used to determine how many contracts can be satisfied by each impression opportunity. Given the impression samples, the admission control module uses the plan to calculate the extent of contention between contracts in the high-dimensional space. Finally, the admission control and pricing module 310 might return allocated available inventory to each of the sales persons without any double-counting. In addition, the admission control module might calculate the price for each contract and return pricing along with the quantity of allocated impression opportunities.

Now, stating the problem to be solved more formally, given an advertising opportunity (e.g. an impression opportunity), specified as a vector (e.g. list) of (feature, value) pairs, find all of the contracts that could bid on this opportunity. For example, given the conjunctive impression opportunity profile vector {(state=CA) AND (gender=male) AND (age=50)}, some possibly matching contracts would include those asking for {(gender=male) AND (state=CA)}, and would include those asking for {(gender=male) AND {(age=50)} because each clause of each of those contracts are satisfied against the example impression opportunity vector. The embodiments of the invention herein permits both disjunctive as well as conjunctive types of contracts and even contracts including more complex predicates to be handled efficiently. As regards contracts including complex predicates, embodiments of the invention disclosed herein support both “IN” (e.g. state IN (NY, CA, MA)) and “NOT-IN” predicates (e.g. state NOT-IN (NY, CA, MA)).

In various embodiments, a contract might be specified in some arbitrarily complex logic expression, which expression can be mathematically transformed into a disjunctive normal form (DNF) or into conjunctive normal form (CNF). A contract specified as a DNF expression contains any number “or” terms, any one of which, if satisfied satisfies the specification of the contract. A contract specified as a CNF expression contains any number of “and” conjunctions, such that all conjunctions must be satisfied in order to satisfy the specification of the contract. Once a contract has been normalized (i.e. into DNF or into CNF) each term can be considered a subcontract. To handle contracts in DNF (OR-ing), the techniques disclosed herein might split a contract into subcontracts (one for each term), and produce an index entry for each of the subcontracts. To support contracts in CNF (AND-ing), the techniques check to confirm that each of the subcontracts is found in the index.

### Section II: Detailed Description of the Problem Solved by an Efficient Inverted Index System

As indicated in the foregoing, one application served by the construction of an efficient inverted index system related to booking and satisfying online advertisement contracts. It should be emphasized that time between an Internet user's click on a link and the display of the corresponding page—including any advertisements is a short period, desirably a fraction of a second. It is within this short time period that applicable contracts must be identified, some or all of those contracts compete for spots on the soon-to-be-displayed webpage, the winner's or winners' advertisements are selected and placed in the webpage, and finally the webpage is rendered at the user's terminal. Thus, an efficient inverted index might be efficient as measured by latency, as well as efficient with respect to computing cycles, especially when many contracts may be booked at any given moment in time.

Further, the inverted index system may receive any arbitrarily complex expressions that describe a contract. The indexing techniques disclosed herein address at least solving the lookup problem efficiently and even under conditions where the input data is complex.

### Syntax and Construction of Contracts and Impression Opportunities

A contract is a DNF expression using IN and NOT-IN predicates as the most basic predicates. An impression opportunity is a point within a multi-dimensional space where any point can be described using finite domains for each attribute along a dimension.

### Section III: Syntax Used in Construction of Inverted Index

### Contract Syntax Using Basic Predicates

There are two types of basic predicates: IN predicates and NOT-IN predicates. For example, the predicate state IN {CA, NY} says that the state could either be CA or NY. The predicate state NOT-IN {CA, NY} indicates the state could be anything other than CA or NY. It is important to observe that state IN {CA, NY} is equivalent to state IN {CA} [symbol] state IN {NY} (making it a disjunction of length 2) while state NOT-IN {CA, NY} is equivalent to state NOT-IN {CA} [symbol] state NOT-IN {NY} (making it a conjunction of length 2). Notice that IN and NOT-IN predicates also cover equality and non-equality predicates. Other basic predicate types might also be supported, but are not required for construction of an inverted index. Using only IN and NOT-IN, for example, ranges of integers can be supported by converting them into equality predicates using hierarchical information of integer ranges.

### Contract Structure

A contract is a DNF or CNF expression on the two basic expressions IN and NOT-IN. For example, (state IN {CA, NY} [symbol] age IN {20}) [symbol] (state NOT-IN {CA, NY} [symbol] interest IN {sports}) is a DNF expression using the two types of atomic expressions while (state IN {CA, NY} [symbol] age IN {20}) [symbol] (interest IN {sports}) is a CNF expression. Notice that a conjunction can either be a DNF expression with one disjunct or a CNF expression with conjuncts of size 1.

### Impression Opportunity Profile

A profile of an impression opportunity is a set of attribute and value pairs. For example, {state=CA [symbol] age=20 [symbol] interest=sports} is a profile. An impression opportunity profile is a single point in a multi-dimensional space. Hence, each attribute within the set defining the impression opportunity profile has exactly one value.

### Section IV. Index Construction for Matching Satisfying Contracts to Impression Opportunities Using Complex Predicates

Construction of an inverted index may commence by making posting lists of contracts for each IN predicate. For each attribute name and single value pair of an IN predicate, we make one posting list. Hence, the index structure “flattens” the IN predicates when constructing the posting lists. In the embodiments described herein, the inverted index is sorted. Furthermore, each posting list might sort its contracts by contract id, and the posting lists themselves might be sorted by the ids of their current contracts. Of course other ids or keys might be used for sorting the posting lists, and/or for sorting contracts within a posting list, and such alternative ids and keys are possible and envisioned. For example, contracts might be sorted by any arbitrary key, such as customer type.

Algorithm 1: Construct Inverted Index

| 1: | input: set of contracts C |
|---|---|
| 2: | output: inverted index idx |
| 3: | idx.init( ) |
| 4: | for all contract c ε C do |
| 5: | for all atomic predicate p ε c do |
| 6: | c′← c /*make copy of contract*/ |
| 7: | if p.type = NOT-IN then |
| 8: | c′.flag ← NOT-IN |
| 9: | end if |
| 10: | for all value [symbol] ε p.list do |
| 11: | idx.getList(p.attrname, v).add(c′) /*make sure to keep the |
| posting lists and the contracts within each posting list sorted*/ | |
| 12: | end for |
| 13: | end for |
| 14: | end for |
| 15: | return idx |

### EXAMPLE

Consider the two contracts in Table 1. For each attribute name and possible value, Algorithm 1 constructs a posting list of contracts with flags. The final inverted index is shown in Table 2. Notice how all the IN predicates are flattened out into single values. Each posting list has its contracts sorted, and the posting lists themselves are also sorted according to the contracts they have.

TABLE 1
A set of contracts

| Contract | Expression |
|---|---|
| c₁ | age IN {1, 2 } [symbol] state IN {CA} |
| c₂ | age IN {1, 2} [symbol] state IN {NY} |
| c₃ | age IN {1, 3} |
| c₄ | state IN {CA} |

TABLE 2
Inverted index for Table 1

| Key | Posting List |
|---|---|
| (age, 2) | c₁ → c₂ |
| (age, 1) | c₁ → c₂ → c₃ |
| (state, CA) | c₁ → c₄ |
| (state, NY) | c₂ |
| (age, 3) | c₃ |

### The Counting Algorithm

In an embodiment known as The Counting Algorithm the algorithm is applied on for contract expressions in the form of conjunctions. The idea is to maintain a counter for each contract on how many predicates of the contract are satisfied. The inverted index for the conditions of the impression opportunity is scanned once. This algorithm can be considered as a baseline algorithm for performance comparison. Notice that the Counting Algorithm can support NOT-IN predicates by modifying Step 8 of Algorithm 2, namely by setting the Count value to minus infinity if the contract is tagged NOT-IN.

Algorithm 2: The Counting Algorithm

| | |
|---|---|
| 1: | input: inverted index idx, set of contracts C, impression I |
| 2: | output: set of contracts O matching I |
| 3: | O ←Ø |
| 4: | Count.init( ) |
| 5: | P ← idx.GetPostingLists(I) /*Get the posting lists of each (name, |

single value) pair of I*/

| | |
|---|---|
| 6: | for i=0..(P.size( ) − 1) do /*for all posting lists*/ |
| 7: | for j=0..(P[i].size( ) − 1) do /*for all contracts within posting |

list*/

| | |
|---|---|
| 8: | Count[P[i][j]]← Count[P[i][j]]+1 |
| 9: | end for |
| 10: | end for |
| 11: | for all c ε C do |
| 12: | if Count[c]= \|c\| then |
| 13: | O ← O ∪{c} |
| 14: | end if |
| 15: | end for |
| 16: | return O |

### EXAMPLE

Consider the impression opportunity I={age= [symbol] state=CA}. Given the inverted index in Table 2, the posting lists for I are shown in Table 3.

TABLE 3
Posting lists for impression opportunity I

| Key | Posting List |
|---|---|
| (age, 1) | c₁ → c₂ → c₃ |
| (state, CA) | c₁ → c₄ |

Scan through the posting lists and increment the counters for each contract. The final counts are shown in Table 4.

TABLE 4
Final counts for the contracts

| Contract | Count |
|---|---|
| c₁ | 2 |
| c₂ | 1 |
| c₃ | 1 |
| c₄ | 1 |

For each contract in Table 4, compare the count value with the number of predicates in the contract (i.e. the size of the contract). As a result, contracts c₁, c₃, and c₄ are satisfied by I because their counts are equal to their sizes.

### Complexity:

The complexity of the Counting algorithm is linear to the sum of the posting list sizes of P:

O(Σ_{k=0 . . . |P|-1}|P[k]|)

### The WAND Algorithm

Another embodiment uses a variant of the WAND algorithm [Broder et al.] The WAND algorithm assumes a conjunction of IN predicates for contracts. Compared to the Counting algorithm, WAND makes the following improvements.
1. WAND exploits the conjunctive form structure of the contracts to skip contracts (in the posting lists) that are guaranteed not to match the impression opportunity.
2. WAND partitions contracts according to their sizes (i.e. number of predicates) and processes one partition at a time. In various embodiments, this partitioning is expeditious when using constant thresholds for finding matching contracts, and the size of each contract is the threshold used for matching.

In this algorithm, contracts of size K=0 (i.e. there are no predicates), are deemed to always match. Since contracts of size K=0 do not appear in the posting lists, a separate posting list (called Z) that contains all contracts of size 0 is maintained. When K=0, Z is always returned by the idx.GetPostingLists method.

In our examples, we denote the posting lists for contracts of size K as P_{K}. For example, the posting lists for contracts of size 2 is denoted as P₂.

Algorithm 3: The WAND Algorithm

| | |
|---|---|
| 1: | input: inverted index idx, set of contracts C, impression I |
| 2: | output: set of contracts O matching I |
| 3: | O ←Ø |
| 4: | MaxSize ←idx.GetMaxContractSize(I) |
| 5: | for K =0..MaxSize do |
| 6: | P ← idx.GetPostingLists(I,K) /*Get posting lists for all the |

contracts that have size K. If K =0, also retrieve Z.*/

| | |
|---|---|
| 7: | if K =0 then /*Other than the additional posting list, the |

processing of K =0 and K =1 is identical*/

| | |
|---|---|
| 8: | K ← 1 |
| 9: | end if |
| 10: | if P.size( )<K then |
| 11: | continue to next for loop |
| 12: | end if |
| 13: | while P[K − 1].Current ≠ null do |
| 14: | SortByContractID(P) /*the cost is logarithmic: one bubbling |

down per posting list advanced*/

| | |
|---|---|
| 15: | if P[0].Current.ID = P[K − 1].Current.ID then |
| 16: | O ← O ∪{P[0].Current} |
| 17: | NextID ← P[K − 1].Current.ID +1 /*NextID is the smallest |

possible ID after current*/

| | |
|---|---|
| 18: | else |
| 19: | NextID ← P[K − 1].Current.ID |
| 20: | end if |
| 21: | for L =0..K − 1 do |
| 22: | P [L].SkipTo(NextID) /*skip to smallest ID in P[L] such |

that ID ≧ NextID*/

| | |
|---|---|
| 23: | end for |
| 24: | end while |
| 25: | end for |
| 26: | return O |

### EXAMPLE

Algorithm 3 extracts the posting lists of I from idx. This time, however, the algorithm extracts posting lists for each possible size of contracts. In Table 1, there are shown two sizes of contracts: size K=1 contains the set of contracts (c₃, c₄) and size K=2 contains the set of contracts (c₁, c₂). Hence, Table 5 shows two sets of posting lists for each size. The current contract of each posting list is underlined. Notice that in this example, the posting lists are in sorted order according to their contract IDs.

TABLE 5
WAND posting lists for impression opportunity I

| Size of Contracts | Key | Posting List |
|---|---|---|
| 1 | (age, 1) | c₃ |
| | (state, CA) | c₄ |
| 2 | (state, CA) | c₁ |
| | (age, 1) | c₁ → c₂ |

Processing continues by processing P1, that is, the posting lists of contracts with size 1. Since P₁[0].Current.ID=P₁[0].Current.ID=3 at Step 15, this example adds c₃ to O in Step 16. The algorithm then skips all the posting lists to c₄ because P[0].Current.ID+1=3+1=4. Hence, P₁[0] reaches the end of the list while P₁[1] still has c₄ as its current contract. The posting lists after sorting P₁ are shown in Table 6. Notice that the posting list of (age, 1) is placed at the end because it is done with processing. Since P₁[0].Current.ID=P₁[0].Current.ID=4 at Step 15, c₄ is also accepted and included in O. After advancing the posting list P₁[0], the algorithm exits the while loop in Step 13.

TABLE 6
Sorted result of P₂ during first loop

| Key | Posting List |
|---|---|
| (state, CA) | c₄ |
| (age, 1) | c₃ → null |

Next, process P2 in the second for loop. Since K is 2 and P₂[0].Current.ID=P₂[1].Current.ID=1, Step 16 adds c₁ to O. Since NextID is 2, we advance both posting lists in P₂ to c₂. Notice that the posting list with key (state, CA) does not contain c₂ and thus points to null, i.e. the end of the list. The posting lists after sorting P₂ in Step 14 are shown in Table 7. This time, P₂[0].Current=c₂ while P₂[1].Current=null, so go back to Step 13. Since P₂[1].Current=null, terminate the while loop and return O={c₁, c₃, c₄} as our result.

TABLE 7
Sorted result of P₂ during second loop

| Key | Posting List |
|---|---|
| (age, 1) | c₁ → c₂ |
| (state, CA) | c₁ → null |

### Complexity:

Although WAND improves the Counting algorithm by using skipping and partitioning techniques, its complexity is actually greater than that of the Counting Algorithm. In the worst case, the WAND Algorithm needs to sort the posting list P while advancing one posting list in Step 22. Sorting in Step 14 actually takes logarithmic time to |P| because the inverted index is initially sorted, and we only need to bubble down one posting list in P using a heap to maintain a sorted order for each posting list advanced. Hence, the complexity becomes

O(log(|P|)×Σ_{k=0 . . . |P|-1}|P[k]|)

### Supporting NOT-IN Predicates

Two possible extensions of Algorithm 3 to support NOT-IN predicates are here disclosed. A simple method is to split the inverted index into a “positive inverted index,” which contains posting lists for the IN predicates, and a “negative inverted index,” which contains posting lists for the NOT-IN predicates. Although this method supports arbitrary conjunctions with NOT-IN predicates, the number of posting lists for an impression opportunity could be large if many contracts contain different NOT-IN predicates. Thus a method that does not use the negative inverted index is desired. In this latter case (the method of which is disclosed below), the inverted index size is bounded by the size of the impression opportunity, making the method practical for real-time applications.

### Using One Inverted Index:

Algorithm 3 might be extended to support NOT-IN predicates without using the negative inverted index. The key idea is to prune contracts whose NOT-IN predicates are violated by the impression opportunity. The motivations for the extensions become more evident in the example presented after the discussion of the algorithm.

1. Extension #1:
The size of a contract is defined as the number of IN predicates (we ignore NOT-IN predicates) within the expression. For example, a contract with 2 IN predicates and 1 NOT-IN predicates has a size of 2, not 3. Intuitively, all contracts whose IN predicates are satisfied are candidates for being completely satisfied (ignoring the NOT-IN predicates for now). The main reason for this re-definition is to prevent “false negatives” where contracts that are actually satisfied are missed. A contract with no IN predicates has a size of 0.

2. Extension #2:
When sorting posting lists in Step 14 of Algorithm 3, assume that c−1<c(NOT-IN)<c<c+1. That is, a posting list with c(NOT-IN) as its current contract is placed before a posting list with c as its current contract. The idea is to reject contracts whose NOT-IN predicate is violated as soon as possible. This sorting order serves to prevent “false positives” where contracts that should be rejected are mistakenly accepted. Notice that the new sorting is not necessary to support NOT-INs and the algorithm instead scans the posting lists that have c as their current contracts until a NOT-IN tag.

3. Extension #3:
Instead of simply comparing P[0].Current and P[K−1].Current as in Step 15, the algorithm extension now additionally checks (after confirming P[0].Current.ID=P[K−1].Current.ID) whether P[0].Current is flagged as NOT-IN. If so, there exists a NOT-IN predicate that is violated, and thus the iteration can immediately reject P[0].Current. Notice the exploitation of the new sorting of Extension #2 to efficiently detect a NOT-IN violation. When a contract is rejected, all the posting lists that have P[0].Current as their current contracts are advanced.

4. Extension #4:
As a corner case, it is possible to have “self-contradicting” contracts that contain both the positive and negative version of the same predicate. For example, contract c={age IN {1} [symbol] A age NOT-IN {1}} is self-contradicting. Such contracts have the property of appearing in the same posting list exactly twice (e.g. the posting list for (age, 1) contains both c and c(NOT-IN)). In this case, processing can safely remove both contract entries because c will never match any impression opportunity.

Algorithm 6 shows the extended WAND algorithm. The only code change made from Algorithm 3 is the addition of Steps 18-27, which reflect Extension 3. Notice the proper support for contracts of size 0 (i.e. they have no IN predicates) because, if K=0, the algorithm always adds the posting list Z that contains all contracts of size 0. Hence, there is no case where a matching contract is missing from the posting lists.

Algorithm 6: The WAND Algorithm Supporting NOT-IN Predicates

| 1: | input: inverted index idx, set of contracts C, impression I |
|---|---|
| 2: | output: set of contracts O matching I |
| 3: | O ←Ø |
| 4: | MaxSize ←idx.GetMaxContractSize(I) /*Get posting lists of all |
| (name,value) pairs of I and partition them by contracts of different | |
| sizes like in Table 13*/ | |
| 5: | for K =0..MaxSize do |
| 6: | P ← idx.GetPostingLists(I,K) /*Get posting lists for all the |
| contracts that have size K. If K =0, also retrieve the posting list Z. | |
| */ | |
| 7: | if K =0 then /*Other than the additional posting list, the |
| processing of K =0 and K =1 is identical*/ | |
| 8: | K ← 1 |
| 9: | end if |
| 10: | if P.size( ) < K then |
| 11: | continue to next for loop |
| 12: | end if |
| 13: | while P[K − 1].Current ≠ null do |
| 14: | SortByContractID(P) /*the cost is O(\|P\|log(\|P\|))*/ |
| 15: | if P [0].Current.ID = P[K − 1].Current.ID then |
| 16: | |
| 17: | /* NEWLY ADDED CODE START */ |
| 18: | if P[0].Current.flag =NOT-IN then /*reject contract if a |
| NOT-IN predicate is violated*/ | |
| 19: | RejectID ← P[0].Current.ID |
| 20: | for i = K..(P.size( )− 1) do /*advance all posting lists |
| with RejectID as their current contracts*/ | |
| 21: | if P[i].Current.ID = RejectID then |
| 22: | P[i].SkipTo(RejectID +1) |
| 23: | else |
| 24: | break out of for loop |
| 25: | end if |
| 26: | end for |
| 27: | continue to next while loop |
| 28: | /* NEWLY ADDED CODE END */ |
| 29: | |
| 30: | else /*contract is fully satisfied*/ |
| 31: | O ← O ∪{P[0].Current} |
| 32: | end if |
| 33: | NextID ← P[K − 1].Current.ID +1 /*NextID is the |
| smallest possible ID after current*/ | |
| 34: | else |
| 35: | NextID ← P[K − 1].Current.ID |
| 36: | end if |
| 37: | for L =0..K − 1 do |
| 38: | P[L].SkipTo(NextID) /*skip to smallest ID in P[L] such |
| that ID ≧ NextID*/ | |
| 39: | end for |
| 40: | end while |
| 41: | end for |
| 42: | return O |

### EXAMPLE

Note the contracts in Table 11. Notice that c₄ is a self-contradicting contract and cannot be satisfied in any way. Also, c₃ is a contract of size 0.

TABLE 11
A set of contracts

| Contract | Expression |
|---|---|
| c₁ | age IN {1, 2} [symbol] state NOT-IN {CA} |
| c₂ | age IN {1, 2} [symbol] state NOT-IN {NY} |
| c₃ | age NOT-IN {3} [symbol] state NOT-IN {NY} |
| c₄ | age IN {1} [symbol] age NOT-IN {1} |

The inverted index constructed by simulating Algorithm 6 over the set of contracts of Table 11 is shown in Table 12. Notice that c₄, the self-contradicting contract, does not appear in the posting list for (age, 1).

TABLE 12
Inverted index for Table 11

| Key | Posting List |
|---|---|
| (state, CA) | c₁(NOT-IN) |
| (age, 2) | c₁ → c₂ |
| (age, 1) | c₁ → c₂ |
| (state, NY) | c₂(NOT-IN)→ c₃(NOT-IN) |
| (age, 3) | c₃(NOT-IN) |

Given an impression opportunity I={age=1 [symbol] state=CA}, the posting lists for I are shown in Table 13. Notice that c₁, c₂ have now been placed in the group of contracts of size 1 because they only have one IN predicate. Contract c₃ is placed in the posting list Z because it has size=0.

TABLE 13
WAND posting lists for impression opportunity I with NOT-IN tags

| Size of contracts | Key | Posting List |
|---|---|---|
| 0 | Z | c₃ |
| 1 | (state, CA) | c₁ (NOT-IN) |
| | (age, 1) | c₁ → c₂ |

Continuing, processing P₀ in Algorithm 6. Since P₀[0].Current.ID=P₀[0].Current.ID=3 at Step 15, accept c₃ and add it to O. Now start processing P₁. Since P₁[0].Current.ID=P₁[0].Current.ID=1 at Step 15, but P₁[0].Current.flag=NOT-IN, we reject c₁ by advancing both the posting lists of (state, CA) and (age, 1). After sorting P₁, the intermediate result is shown in Table 14.

TABLE 14
Sorted P1 in second while loop

| Key | Posting List |
|---|---|
| (age, 1) | c₁ → c₂ |
| (state, CA) | c₁(NOT-IN)→ null |

During the next while loop, include c₂ in O because P₁[0].Current.ID=P₁[0].Current.ID=2 and P₁[0].Current.flag≠NOT-IN. Then escape the while loop at the next while condition and terminate, returning O={c₂, c₃} as the result.

### Complexity:

Unlike Algorithm 3, the sorting in Step 14 takes O(|P|log(|P|)) time because of the new sorting we use for contracts with NOT-IN tags. For example, consider the two posting lists (age, 1): c₁→c₂ and (state, CA): c₁→c₃, which are in sorted order of contract IDs. If we do not use any NOT-IN tags, then the two posting lists are still sorted even after advancing them by one contract. However, consider use of NOT-IN tags and have (age, 1): c₁→c₂ and (state, CA): c₁(NOT-IN)→c₃. Then according to the new sorting, (state, CA) now precedes (age, 1) because c₁(NOT-IN)<c₁. However, this implies a re-sort of the two posting lists once they are advanced because the ordering of c₂ and c₃ is disrupted. Hence Step 14 needs to do an entire sort again. Even skipping the new ordering (i.e. c(NOT-IN)<c), we then need to do a O(|P|) scan in Step 18 instead of a single equality check, making the overall algorithm still have the complexity:

O(|P|log(|P|)×Σ_{k=0 . . . |P|-1}|P[k]|)

### Supporting DNF Expressions

The WAND Algorithm can be further extended to support DNF expressions. The idea of Algorithm 7 is to decompose contracts into smaller contracts that have conjunctive expressions and run WAND as if they were separate contracts. After WAND terminates, then return the contracts that have any of their subcontracts in the output O. Notice that Algorithm 7 can be easily combined with other techniques herein to support DNF expressions containing NOT-IN predicates.

Algorithm 7: The WAND Algorithm for DNF Expressions

| | |
|---|---|
| 1: | input: inverted index idx, set of contracts C, impression I |
| 2: | output: set of contracts matching I |
| 3: | S ←Ø |
| 4: | for all c ε C do |
| 5: | S ← S ∪ GetDisjuncts(c) |
| 6: | end for |
| 7: | O ← WAND(idx, S, I) |
| 8: | return all contracts that have any of their disjuncts in O |

### EXAMPLE

Consider the DNF contracts shown in Table 15 and the impression opportunity I={age=1 [symbol] state=CA}.

TABLE 15
A set of contracts

| Contract | Expression |
|---|---|
| c₁ | age IN {1} [symbol] state IN {CA} |
| c₂ | age IN {1} [symbol] (age IN {2} [symbol] state IN {NY}) |
| c₃ | age NOT-IN {1} [symbol] state IN {NY} |

First extract the disjuncts of all contracts and form “subcontracts” as shown in Table 16.

TABLE 16
A set of contracts

| Contract | Expression |
|---|---|
| c₁¹ | age IN {1} |
| c₁² | state IN {CA} |
| c₂¹ | age IN {1} |
| c₂² | age IN {2} [symbol] state IN {NY} |
| c₃ | age NOT-IN {1} [symbol] state IN {NY} |

After running WAND, we get the satisfying subcontracts {c₁¹, c₁², c₂¹}. Thus we return the contracts {c₁, c₂} as the final solution.

### Supporting CNF Expressions

Algorithm 3 can be extended to support CNF expressions. The idea is to use the WAND algorithm on the outer conjunctions of the CNF expressions of contracts. The following extensions from Algorithm 3 are made.

1. Extension #5:
Define the size of a contract as the number of conjuncts (instead of disjuncts).

2. Extension #6:
A contract c in a posting list now contains an ID of the conjunct that contains the posting list predicate (see Table 18 for an example). For each satisfying contract c that is in at least K=|c| posting lists, additionally check whether |c| different conjuncts of c are satisfied. For example, if c={age=1 [symbol] (gender=M [symbol] state=CA)}, then make sure that the two conjuncts of c are satisfied. If the impression opportunity is I={age=1 [symbol] gender=M}, then c is satisfied. On the other hand, if I={gender=M [symbol] state=CA}, then c is not satisfied because only the second conjunct is satisfied. Notice that more than one conjuncts may contain the same predicate. For example, in c={(age=1 [symbol] state=CA) [symbol] (age=1 [symbol] state=NY)}, the predicate age=1 is contained in both conjuncts of c. In this case, make a separate posting list for each distinct conjunct ID. (If many contracts have multiple conjunct IDs for the same posting list, make duplicates of the posting list as many as the maximum number of distinct conjunct IDs among the contracts.) This operation is needed for the CNF algorithm to do skipping in a WAND fashion as shown in the subsequent examples. The downside of duplicating posting lists, however, is that the sorting cost increases. Alternatively, it is possible to avoid the duplication by defining the size of a contract c as the minimum number of predicates to satisfy c. (The size of c={(age=1 [symbol] state=CA) [symbol] (age=1 [symbol] state=NY)} is then 1.) One embodiment stores several conjunct IDs in the same contract of a posting list. Instead of simple comparing the 1st and Kth posting list, scan all the posting lists that have c as their current contracts and union the conjunct IDs.

The only code change in Algorithm 8 compared to Algorithm 3 is the inclusion of Steps 18-26, which reflects the Extension #6 above.

Algorithm 8: The WAND Algorithm for CNF Expressions

| 1: | input: inverted index idx, set of contracts C, impression I |
|---|---|
| 2: | output: set of contracts O matching I |
| 3: | O ←Ø |
| 4: | MaxSize ←idx.GetMaxContractSize(I) |
| 5: | for K =0..MaxSize do |
| 6: | P ← idx.GetPostingLists(I,K) /*Get posting lists for all the |
| contracts that have size K. If K =0, also retrieve the posting list | |
| Z*/ | |
| 7: | if K =0 then /*Other than the additional posting list, the |
| processing of K =0 and K =1 is identical*/ | |
| 8: | K ← 1 |
| 9: | end if |
| 10: | if P.size( )< K then |
| 11: | continue to next for loop |
| 12: | end if |
| 13: | while P[K − 1].Current ≠ null do |
| 14: | SortByContractID(P) /*the cost is linear: one bubbling down |
| per posting list advanced*/ | |
| 15: | if P[0].Current.ID = P[K − 1].Current.ID then |
| 16: | |
| 17: | /* NEWLY ADDED CODE START */ |
| 18: | ConjunctIDSet ←Ø |
| 19: | for i =0..(P.size( )− 1) do |
| 20: | if P[i].Current.ID = P [0].Current.ID then |
| 21: | ConjunctIDSet ← ConjunctIDSet |
| | ∪{P[i].Current.ConjunctID} |
| 22: | else |
| 23: | break out of for loop |
| 24: | end if |
| 25: | end for |
| 26: | if \|ConjunctIDSet\| = K then /*contract is fully |
| satisfied*/ | |
| 27: | /* NEWLY ADDED CODE END */ |
| 28: | |
| 29: | O ← O ∪{P[0].Current} |
| 30: | end if |
| 31: | NextID ← P[K − 1].Current.ID +1 /*NextID is the smallest |
| possible ID after current*/ | |
| 32: | else |
| 33: | NextID ← P[K − 1].Current.ID |
| 34: | end if |
| 35: | for L =0..K − 1 do |
| 36: | P [L].SkipTo(NextID) /*skip to smallest ID in P [L]such |
| that ID ≧ NextID*/ | |
| 37: | end for |
| 38: | end while |
| 39: | end for |
| 40: | return O |

### EXAMPLE

Consider the contracts in Table 17. The inverted index is shown in Table 18. Notice the conjunct ID is placed after each contract, indicating which conjunct of the contract the posting list predicate is located in. For example, posting list predicate (state, CA) is located in the second conjunct of c₁, and thus, add the tag “(2)” to c₁. Also notice that there are two posting lists for (age, 1) because c₃ has two conjunct IDs.

Given an impression opportunity I={age=1 [symbol] gender=F}, the posting lists for I are shown in Table 27.

TABLE 17
A set of contracts

| Contract | Expression |
|---|---|
| c₁ | age IN {1} [symbol] (gender IN {F} [symbol] state IN {CA}) |
| c₂ | (age IN {1} [symbol] gender IN {F}) [symbol] state IN {CA} |
| c₃ | (age IN {1} [symbol] gender IN {F}) [symbol] (age IN {1} [symbol] state IN {CA}) |
| c₄ | (age IN {1, 2} [symbol] gender IN {F}) |

TABLE 18
Inverted index for Table 17

| Key | Posting List |
|---|---|
| (state, CA) | c₁(2)→ c₂(2)→ c₃(3) |
| (age, 1) | c₁(1)→ c₂(1)→ c₃(1)→ c₄(1) |
| (gender, F) | c₁(2)→ c₂(1)→ c₃(1)→ c₄(1) |
| (age, 1) | c₃(2) |
| (age, 2) | c₄(1) |

### Processing P₁ in Algorithm 8:

Since P₁[0].Current.ID=P₁[0].Current.ID=4 at Step 15, start counting the number of distinct conjuncts for c₄ by scanning the posting lists that have c₄ as their current contracts (hence, consider both posting lists of P₁). Since both posting list predicates (age, 1) and (gender, F) are in the first conjunct, |ConjunctIDSet|=|{1}|=1=K. Hence, accept c₄ and add it to O. After processing P₁, start processing P₂. Since P2[0].Current.ID=P₂[1].Current.ID=1 at Step 15, start counting the number of distinct conjuncts for c₁. Since |ConjunctIDSet|=|{1, 2}|=2=K, add c₁ to O. After advancing the two posting lists, the intermediate state of the posting lists of P₂ is shown in Table 20. Since P₂[0].Current.ID=P₂[1].Current.ID=2 at Step 15, start counting the number of distinct conjuncts for c₂. This time, however, |ConjunctIDSet|=|{1}|=1<2=K, so we reject c₂. We advance the two posting lists again, arriving at Table 21. Since |ConjunctIDSet|=|{1}∪{1}∪{2}|=|{1, 2}|=2=K, add c₃ to O. Hence, return the final result O={c₁, c₃, c₄}.

Supporting CNF Expressions with NOT-IN Predicates

Further embodiments implement two possible extensions to support CNF expression with NOT-IN predicates. As earlier indicated a simple method is to split the inverted index into positive and negative inverted indexes however, an enhanced method described below does not use the negative inverted index. The inverted index size is then bounded by the size of the impression opportunity, making the enhanced method practical for real-time applications. We explain each option in the next sections.

One important intuition to have is that, the more complex the contract expression, the more information is needed in the posting lists and the more operations are needed to perform in order to tell if the contract is really satisfied. To reduce complexity, the extensions are defined to use a minimum of information and expend a minimum of work to evaluate the contract. To reduce runtimes, some simplifications or restrictions (e.g. limiting depth of predicates within a conjunct) are applied.

### Using One Inverted Index:

One embodiment of an enhanced algorithm for CNF expressions with NOT-IN predicates uses one inverted index.

1. Extension #8:
The size of a contract is the number of conjuncts that do not contain any NOT-IN predicates. For example, the size of c={(age IN {1, 2}) \hat{0} (gender IN {M} v state NOT-IN {CA, NY})} is 1.

2. Extension #9:
A contract in a posting list contains the NOT-IN flag, conjunct ID, and the number of NOT-IN predicates in the conjunct. For example, the contract c above in the posting list (state, CA) would contain the information (flag=NOT-IN, ConjID=2, NOTCnt=1).

3. Extension #10:
For each candidate contract c that is returned by WAND, create an array of integers where each integer is assigned to a conjunct of c and is used as a counter to determine whether the conjunct is satisfied or not. The counters are all initialized to 0. Also, distinguish the counters between “type 1” conjuncts that only contain IN predicates and “type 2” conjuncts that contain at least one NOT-IN predicate. If a conjunct does not contain any NOT-IN predicates, the counter is simply set to 1 for any IN predicate satisfied. If a conjunct contains n>0 NOT-IN predicates and has a count 0, its counter is set to the quantity (−n −1) and from then on incremented by 1 for each NOT-IN predicate violated or else the counter is set to 1 if any IN predicate is satisfied. A type 1 conjunct is satisfied if the count is positive and not satisfied if the count is 0. A type 2 conjunct is satisfied if the count is 1 (i.e. at least one IN predicate was satisfied), the count is 0 (i.e. no posting list contains the conjunct ID, which means that at least one NOT-IN predicate was satisfied) or the count is less than −1 (i.e. at least one NOT-IN predicate was satisfied) and is not satisfied if the count is −1 (i.e. all NOT-IN predicates were violated while no IN predicate was satisfied).

Algorithm 10 reflects the ideas above. The only code change compared to Algorithm 3 is the inclusion of Steps 18-40, which reflects the Extension #10 above.

Algorithm 10: The WAND Algorithm for
CNF Expressions with NOT-IN Predicates

| | |
|---|---|
| 1: | input: inverted index idx, set of contracts C, impression I |
| 2: | output: set of contracts O matching I |
| 3: | O ←Ø |
| 4: | MaxSize ←idx.GetMaxContractSize(I) |
| 5: | for K =0..MaxSize do |
| 6: | P ← idx.GetPostingLists(I,K) /*Get posting lists for all the |

contracts that have size K. If K =0, also retrieve the posting list
Z*/

| | |
|---|---|
| 7: | if K =0 then /*Other than the additional posting list, the |

processing of K =0 and K =1 is identical*/

| | |
|---|---|
| 8: | K ← 1 |
| 9: | end if |
| 10: | if P.size( )< K then |
| 11: | continue to next for loop |
| 12: | end if |
| 13: | while P[K − 1].Current ≠ null do |
| 14: | SortByContractID(P) |
| 15: | if P[0].Current.ID = P[K − 1].Current.ID then |
| 16: | |
| 17: | /* NEWLY ADDED CODE START */ |
| 18: | A ←new CountArray(P[0].Current.size) /*all counters |

initialized to 0*/

| | |
|---|---|
| 19: | for i =0..(P.size( )− 1) do |
| 20: | if P[i].Current.ID = P[0].Current.ID then |
| 21: | if A[P[i].Current.ID].isType2 = true [symbol] |

A[P[i].Current.ID].Cnt = 0 then /*initialize counter for Type2
conjunct*/

| | |
|---|---|
| 22: | A[P[i].Current.ID].Cnt ←−1− P[i].Current.NOTCnt |
| 23: | end if |
| 24: | if P[i].Current.flag ≠NOT-IN then |
| 25: | A[P[i].Current.ID].Cnt ← 1 |
| 26: | else if A[P[i].Current.ID].Cnt ≠1 then |
| 27: | A[P[i].Current.ID].Cnt ← A[P[i].Current.ID].Cnt +1 |
| 28: | end if |
| 29: | else |
| 30: | break out of for loop |
| 31: | end if |
| 32: | end for |
| 33: | Satisfied ← true |
| 34: | for i =0..\|A\|− 1 do |
| 35: | if ((A[P[i].Current.ID].isType2 = true [symbol] A[P[i]. |

Current.ID].Cnt = −1) [symbol] (A[P[i].Current.ID].isType2 = false [symbol] A[P[i].
Current.ID].Cnt =0) then

| | |
|---|---|
| 36: | Satisfied ← false |
| 37: | break out of for loop |
| 38: | end if |
| 39: | end for |
| 40: | if Satisfied = true then |
| 41: | /* NEWLY ADDED CODE END */ |
| 42: | |
| 43: | O ← O ∪{P[0].Current} |
| 44: | end if |
| 45: | NextID ← P[K − 1].Current.ID +1 /*NextID is the |

smallest possible ID after current*/

| | |
|---|---|
| 46: | else |
| 47: | NextID ← P[K − 1].Current.ID |
| 48: | end if |
| 49: | for L =0..K − 1 do |
| 50: | P[L].SkipTo(NextID)/*skip to smallest ID in P[L]such |

that ID ≧ NextID*/

| | |
|---|---|
| 51: | end for |
| 52: | end while |
| 53: | end for |
| 54: | return O |

### EXAMPLE

Consider the contracts in Table 25.

TABLE 25
A set of contracts

| Contract | Expression |
|---|---|
| c₁ | age IN {1} [symbol] (state NOT-IN {CA} [symbol] gender NOT-IN {M}) |

The inverted index is shown in Table 26.

TABLE 26
Inverted index for Table 25

| Key | Posting List |
|---|---|
| (age, 1) | c₁(flag = IN, ConjID = 1, NOTCnt = 0) |
| (state, CA) | c₁(flag = NOT-IN, ConjID = 2, NOTCnt = 2) |
| (gender, M) | c₁(flag = NOT-IN, ConjID = 2, NOTCnt = 2) |

Given an impression opportunity I={age=1 [symbol] gender=M [symbol] state=NY}, the posting lists for I are shown in Table 27.

### Processing P₁ in Algorithm 10:

Since P₁[0].Current.ID=P₁[0].Current.ID=1 at Step 15, start evaluating c₁ based on the information in the posting lists. Create the array A which contains two counters for the two conjuncts of c₁. Since the first posting list is an IN predicate for c₁, we set A[0].Cnt to 1. Since the second posting list is a NOT-IN predicate, initialize A[1].Cnt to the quantity (−2 −1)=−3 and then increment it to −2. Then accept c₁ because A[0].Cnt=1 and A[1].Cnt<−1.

TABLE 27
WAND posting lists for impression opportunity I with
CNFs with NOT-IN predicates

| Size of contracts | Key | Posting List |
|---|---|---|
| 1 | (age, 1) | c₁(flag = IN, ConjID = 1, NOTCnt = 0) |
| | (gender, M) | c₁(flag = NOT-IN, ConjID = 2, |
| | | NOTCnt = 2) |

Suppose, on the other hand, that I₂={age=1 [symbol] gender=M [symbol] state=CA}. Then the posting lists for I₂ are shown in Table 28. In this case, A[0].Cnt=1 and A[1].Cnt=−1. The algorithm thus rejects c₁ because A[1].Cnt=1.

TABLE 28
WAND posting lists for impression opportunity I₂ with
CNFs with NOT-IN predicates

| Size of | | |
|---|---|---|
| contracts | Key | Posting List |
| 1 | (age, 1) | c₁(flag = IN, ConjID = 1, NOTCnt = 0) |
| | (gender, M) | c₁(flag = NOT-IN, ConjID = 2, NOTCnt = 2) |
| | (state, CA) | c₁(flag = NOT-IN, ConjID = 2, NOTCnt = 2) |

Suppose that I₃={age=1 [symbol] gender=F [symbol] state=NY}. Then the posting lists for I₃ are shown in Table 29. In this case, A[0].Cnt=1 and A[1].Cnt=0. Notice that A[1].Cnt=0 because none of the posting lists contain the second conjunct. Since the second conjunct is type 2, it has at least one NOT-IN predicate satisfied, thus c₁ is accepted.

Finally, suppose that I₄={age=2 [symbol] gender=F [symbol] state=NY}. Then there are no posting lists. Since A[0]=0, reject c₁.

TABLE 29
WAND posting lists for impression opportunity I3 with
CNFs with NOT-IN predicates

| Size of contracts | Key | Posting List |
|---|---|---|
| 1 | (age, 1) | c₁(flag = IN, ConjID = 1, NOTCnt = 0) |

Algorithm 10 has now been extended from the original WAND algorithm 3 and now, able to build an inverted index of contracts when the set of contracts contains targets reduced to CNF expressions containing NOT-IN predicates.

### Section V. Index Construction for Matching Highest Scoring Contracts to Impression Opportunities Using Complex Predicates

As shown above, Algorithm 10 has been extended to include building an inverted index of contracts when the set of contracts contains targets reduced to CNF expressions, even when containing NOT-IN predicates. Still further improvements are possible and envisioned. In particular, the disclosure of this section provides several approaches to handling an inverted index that includes weighting. Suppose each contract, in addition to being specified with any arbitrarily complex Boolean expression (BE) also has an association with one or more weighting coefficients, which coefficients can be used in a quantitative calculation of a goodness score. The ability to calculate a goodness score implies that not all contracts that satisfy some particular Boolean expression need be regarded as equal. The inverted index embodiments of Section IV serve for efficiently retrieving all matching contracts. The algorithms and data structures are applied and extended for efficiently retrieving the top N contracts.

One approach for retrieving the top N contracts would be to first find all of the matching contracts, calculate the goodness score for each, then sort by the goodness score and return only the top N. As aforementioned, the total number of matching contracts may be a large number (e.g. in the hundreds or thousands or more), thus, the application of such an approach involves significant computational power for scoring the total number of matching contracts, even though the number of top N contracts might be a quite small number (e.g. 5, 10, 20, etc). As described in detail below, the techniques for matching highest scoring contracts to impression opportunities include storing the calculated goodness scoring in the index data structure, supporting retrieval techniques to skip low scoring goodness contracts, and thus offering efficient retrieval of the top N contracts.

### Scoring

The weighted score of a BE E reflects the “relevance” or goodness of E to an assignment (i.e. an assignment being an impression opportunity) S. For example, a user interested in sports might be more interested in an advertisement for sport shoes than an advertisement for flowers. If E is a conjunction of ∈ and ∉ predicates, the score of E is defined as

Score_{conj}(E, S)=Σ_{(A,ν)∈IN(E)∩S}w_{E}(A,ν)×w_{S}(A,ν)

where IN(E) is the set of all attribute name and value pairs in the E predicates of E (scoring ∉ predicates is ignored, and w_{E}(A,ν) is the weight of the pair (A,ν) in E). Similarly, w_{S}(A,ν) is the weight for (A,ν) in S. For example, a BE age ∈{1,2}\hat{0}state ∈ {CA} could be targeting young people in California, giving the pair (age, 1) a high weight of 10 while giving (age, 2) a lower weight of 5 and (state, CA) a weight of 3. If there is an assignment {age=1, state=CA}, where the first pair has a weight of 1 while the second pair has a weight of 2, the score of the BE to the assignment is 10×1+3×2=16.

In order to do top-N pruning, an upper bound UB(A,ν) is generated for each attribute name and value pair (A,ν) such that

UB(A,ν)≧max (w_{E}_{₁} (A,ν), w_{E}_{₂} (A, ν) . . . )

For instance, if UB(age, 1)=10, then (age, 1) may not contribute more than a weight of 10 regardless of the BE.

### DNF Scoring

The score of a DNF BE E is defined as the maximum of the scores of the conjunctions within E where E.i denotes the ith conjunction of E and |E| the number of conjunctions in E.

Score_{DNF}(E, S)=max_{i=1 . . . |E|}Score_{conj}(E.i, S)

Intuitively, the DNF score is equal to the contribution of just one conjunction, that being the conjunction scoring the highest from among the group of conjunctions comprising the DNF expression.

### CNF Scoring

The score of a CNF BE E is similar to Score_{conj} and is defined as the sum of the disjunction scores (using Score_{DNF}) within E where E.i denotes the ith disjunction of E and |E| the number of disjunctions in E.

Score_{CNF}(E, S)=Σ_{i=1 . . . |E|}Score_{DNF}(E.i, S)

Intuitively, the CNF score combines all the contributions of each disjunction.

### Inverted List Construction for DNF Representations

The discussion below describes how to build an inverted list data structure on the conjunctions of the BEs. First, create predicate size partitions by partitioning all the conjunctions by their sizes (i.e. number of predicates). The partition with conjunctions of size K are referred to as the K-index. Then, for each K-index, create posting lists for all possible attribute name and value pairs (also called keys) among the conjunctions. A posting list head contains the key (A,ν). In an exemplary embodiment, each entry of a posting list represents a conjunction c and contains the ID of c as well as a bit indicating whether the key (A,ν) is involved in an ∈ or ∉ predicate in c. A posting list entry e₁ is “smaller” than another entry e₂ if the conjunction ID of e₁ is smaller than that of e₂. In the case where both conjunction IDs are the same (in which case e₁ and e₂ appear in different lists), e₁ is smaller than e₂ only if e₁ contains a ∉ while e₂ contains an ∈. Otherwise, the two entries are considered the same. Using this ordering, the entries in a posting list are sorted in increasing entry order, while in each K-index, the posting lists themselves are sorted in increasing entry order of their first entry. Notice there are no two entries with the same conjunction ID within the same posting list because an attribute is only allowed to occur once in each conjunction. Keeping the posting lists sorted in each K-index reduces the sorting time of posting lists as is performed in some of the algorithms presented herein (e.g. as in the Conjunction Algorithm, shown below).

As a special case, conjunctions of size 0 (e.g. age ∉ {3} is a conjunction of size 0 because it has no ∈ predicates) are all included in a single posting list called Z. This special posting list is needed to ensure that zero-sized conjunctions appear in at least one posting list given an assignment. In addition, each entry in Z contains an ∈ predicate. This modification ensures that Algorithm 11 also works for zero-sized conjunctions.

### EXAMPLE

Consider the conjunctions in Table 30. The conjunctions are first partitioned according to their sizes (c₁,c₂,c₃,c₄ each have a size of 2, c₅ has a size 1, and c₆ has a size 0). For each size partition K=0,1,2 . . . , Table 31 shows the construction of the K-indexes. For instance, the key (age, 4) has a posting list inside the partition K=1 and contains an entry representing c₅. Notice that the weight for any entry that has a NOT-IN indication (i.e. ∉) is partitioned into the K=0 partition because NOT-IN predicates are not considered for scoring.

TABLE 30
A set of conjunctions

| Contract | Expression |
|---|---|
| c₁ | age ∈ {3} [symbol] state ∈ {NY} |
| c₂ | age ∈ {3} [symbol] gender ∈ {F} |
| c₃ | age ∈ {3} [symbol] gender ∈ {M} [symbol] state ∉ {CA} |
| c₄ | state ∈ {CA} [symbol] gender ∉ {M} |
| c₅ | age ∈ {3, 4} |
| c₆ | state ∉ {CA, NY} |

TABLE 31
Inverted list corresponding to Table 30

| K | Key & UB | Posting List |
|---|---|---|
| 0 | (state, CA), 2.0 | (6, ∉, 0) |
| | (state, NY), 5.0 | (6, ∉, 0) |
| | Z, 0 | (6, ∈, 0) |
| 1 | (age, 3), 1.0 | (5, ∈, 0.1) |
| | (age, 4), 3.0 | (5, ∈, 0.5) |
| 2 | (state, NY),5.0 | (1, ∈, 4.0) |
| | (age, 3), 1.0 | (1, ∈, 0.1) (2, ∈, 0.1) (3, ∈, 0.2) |
| | (gender, F), 2.0 | (2, ∈, 0.3) |
| | (state, CA), 2.0 | (3, ∉, 0) (4, ∉, 1.5) |
| | (gender, M), 1.0 | (3, ∈, 0.5) (4, ∈, 0.9) |

### Conjunction Algorithm

The Conjunction Algorithm (Algorithm 11) returns all the satisfying conjunctions given an assignment. The following two observations are incorporated into Algorithm 11 for efficiently finding a conjunction c that matches an assignment A with t keys:

(1) For a K-index (K≦t), a conjunction c (with K terms) matches A only if there are exactly K posting lists where each list is for a key (A,ν) in A and the ID of c is in the list with an ∈ annotation.

(2) For no (A,ν) keys in A should there be a posting list where c occurs with a ∉ annotation.

Algorithm 11: The Conjunction Algorithm

| 1: | input: inverted list idx and assignment S |
|---|---|
| 2: | output: set of conjunctions IDs O matching S |
| 3: | O ←Ø |
| 4: | for K=min(idx.MaxConjunctionSize, \|S\|)...0 do |
| 5: | /* List of posting lists matching A for conjunction size K */ |
| 6: | PLists ← idx.GetPostingLists(S,K) |
| 7: | InitializeCurrentEntries(PLists) |
| 8: | /* Processing K=0 and K=1 are identical */ |
| 9: | if K=0 then K ← 1 |
| 10: | /* Too few posting lists for any conjunction to be satisfied */ |
| 11: | if PLists.size( ) < K |
| 12: | continue to next for loop iteration |
| 13: | while PLists[K−1].CurrEntry ≠EOL |
| 14: | SortByCurrentEntries(PLists) |
| 15: | /* Check if the first K posting lists have the same |
| conjunction ID in their current entries */ | |
| 16: | if PLists[0].CurrEntry.ID = PLists[K−1].CurrEntry.ID |
| | then |
| 17: | /* Reject conjunction if a ∉ predicate is violated */ |
| 18: | if PLists[0].CurrEntry.AnnotatedBy(∉) then |
| 19: | RejectID ← PLists[0].CurrEntry.ID |
| 20: | for L = K .. (PLists.size( )−1) do |
| 21: | if PLists[L].CurrEntry.ID = RejectID then |
| 22: | /* Skip to smallest ID where ID > RejectID */ |
| 23: | PLists[L].SkipTo(RejectID+1) |
| 24: | else |
| 25: | break out of for loop |
| 26: | continue to next while loop iteration |
| 27: | else [ conjunction is fully satisfied ] |
| 28: | O ← O ∪ {PLists[K−1].CurrEntry.ID} |
| 29: | /* NextID is the smallest possible ID after current |
| ID*/ | |
| 30: | NextID ← PLists[K−1].CurrEntry.ID + 1 |
| 31: | else |
| 32: | /* Skip first K−1 posting lists */ |
| 33: | NextID ← PLists[K−1].CurrEntry.ID |
| 34: | L = 0...K−1 do |
| 35: | /* Skip to smallest ID such that ID ≧ NextID */ |
| 36: | PLists[L].SkipTo(NextID) |
| 37: | return O |

Algorithm 11 iterates through the K-indexes (K in the inverted list (Step 4) and adds the satisfied conjunction IDs into O. Of note, Algorithm 11 does not need to further consider K-indexes (K≦t) with K>t since conjunctions in those indexes have more terms than what can be satisfied by S. For each conjunction size K, the GetPostingLists(S,K) method is used to extract the posting lists that match A (Step 6). PLists is thus a list of posting lists. In the case where K=0, GetPostingLists(S,K) returns the Z posting list in addition to the other posting lists matching A. Each posting list has a “current entry” (denoted as CurrEntry) that is initialized to the first entry in the list (Step 7). If K=0, then set K=1 (Step 9) once the posting lists are extracted because the processing of the posting lists for K=0 is identical to that of K=1. The optimization of Step 11 skips processing the conjunction size K if the number of posting lists is smaller than K (because no conjunction can be satisfied).

From Step 13, Algorithm 11 starts skipping posting lists for conjunctions that are guaranteed not to match the assignment. This skipping is an extension and adaptation of the earlier-described WAND algorithm (Algorithm 3) for the purpose of evaluating and skipping complex expressions. The SortByCurrentEntries(PLists) method first sorts the list of matching posting lists by their current entries. At this point, consider the first entry in the first list (PLists[0].CurrEntry). Consider for example if this entry has an ∈ annotation and is for conjunction c. In such a case, the only way c can match S is if for lists PLists[0] through PLists[K−1], c happens to be the first entry, too. Because of the way the lists are sorted, this condition can be checked by only checking the last list (Step 16). As another example of this skipping, consider if the condition of Step 16 is not satisfied because PLists[K−1].CurrEntry.ID is d (>c). Note that in this case, the algorithm does not need to consider conjunctions c,c+1, . . . d−1 as they do not have the necessary K lists. Thus, Algorithm 11 skips ahead to consider conjunction d, as done in lines 34-36. The SkipTo(NextID) method advances the current entry of a posting list until the conjunction ID of the current entry is larger or equal to NextID. The effect of skipping becomes significant for a large number of conjunctions.

If PLists[0] and PLists[K−1] have the same conjunction ID in their current entries at Step 16, then Step 18 checks whether any ∉ predicate of the conjunction was violated by looking at the current entry of the first posting list. The aforementioned sorting condition for entries (i.e. posting lists are sorted in increasing order) guarantees that Algorithm 11 can determine whether a ∉ predicate of a conjunction has been violated by checking only the first posting list. If the conjunction is violated, skip all the posting lists with the violated ID in their current entries to their next entries (Steps 23 and 36). If the conjunction is not violated, then conclude that the conjunction is satisfied and add the ID of the conjunction into O (at Step 28). The algorithm terminates when the K th posting list is empty (i.e. the current entry points to the end of the posting list).

### Inverted List Construction for CNF Representations

In comparison to the inverted index for conjunctions, a posting list entry for key (A,ν) may be extended to contain the ID of the disjunction containing the predicate of (A,ν). As a result, there may be multiple entries for one CNF in the same posting list with different disjunction IDs. Since Algorithm 12 below requires each posting list to contain at most one entry per CNF (to prevent false negative indications where a matching CNF is mistakenly rejected having too few posting lists), Algorithm 12 stores entries with the same CNF ID in different posting lists with the same key. In the case where there are duplicate entries for more than one CNF, Algorithm 12 creates posting lists with the same key until any posting list has at most one entry per CNF, and assign entries to the first posting list available in a greedy fashion.

### EXAMPLE

Consider the six CNF BEs in Table 32. The CNFs are first partitioned according to their sizes (c₁ through c₄ have a size 2, c₅ has a size 1, and c₆ has a size 0). For each partition K=0,1,2, . . . construct the K-indexes as shown in Table 32. Each posting list entry (e.g. “(6,∈,0,0.1)”) now contains its disjunction ID as its 3rd value (e.g. “0”). The posting lists also contain a 4th value (e.g. “0.1”) being the weighting coefficient (further discussed infra). Continuing this example, the only entry in the (A,2) posting list indicates that the predicate for (A,2) is in the first disjunction of c₄. Also notice that for c₄, the key (A,1) appears in both of its disjunctions. Hence, the posting list (A,1) is duplicated where the first list contains entry (4,∈,0,0.1) while the second list contains (4,∈,1,0.5). For the other entries of (A,1) simply add them to the first posting list of (A,1) in a greedy fashion.

TABLE 32
A set of CNF expressions

| ID | Expression |
|---|---|
| c₁ | (A ∈ {1} [symbol] B ∈ {1}) [symbol] (C ∈ {1} [symbol] D ∈ {1}) |
| c₂ | (A ∈ {1} [symbol] C ∈ {2}) [symbol] (B ∈ {1} [symbol] D ∈ {1}) |
| c₃ | (A ∈ {1} [symbol] B ∈ {1}) [symbol] (C ∈ {2} [symbol] D ∈ {1}) |
| c₄ | (A ∈ {1} [symbol] B ∈ {1}) [symbol] (A ∈ {1, 2} [symbol] D ∈ {1}) |
| c₅ | (A ∈ {1} [symbol] B ∈ {1}) [symbol] (C ∉ {1, 2} [symbol] D ∉ {1} [symbol] E ∈ {1}) |
| c₆ | A ∉ {1} [symbol] B ∈ {1} |

TABLE 33
Inverted list corresponding to Table 32

| K | Key & UB | Posting List |
|---|---|---|
| 0 | (A, 1), 0.5 | (6, ∉, 0, 0) |
| | (B, 1), 1.5 | (6, ∈, 0, 0.1) |
| | Z, 0 | (6, ∈, −1, 0) |
| 1 | (C, 1), 2.5 | (5, ∉, 1, 0) |
| | (C, 2), 3.0 | (5, ∉, 1, 0) |
| | (D, 1), 3.5 | (5, ∉, 1, 0) |
| | (A, 1), 0.5 | (5, ∈, 0, 0.1) |
| | (B, 1), 1.5 | (5, ∈, 0, 0.7) |
| | (E, 1), 4.5 | (5, ∈, 1, 3.9) |
| 2 | (A, 1), 0.5 | (1, ∈, 0, 0.1) (2, ∈, 0, 0.3) (3, ∈, 0, 0.3) (4, ∈, 0, 0.1) |
| | (B, 1), 1.5 | (1, ∈, 0, 0.3) (2, ∈, 1, 0.5) (3, ∈, 0, 0.3) (4, ∈, 0, 0.5) |
| | (C, 1), 2.5 | (1, ∈, 1, 0.2) |
| | (D, 1), 3.5 | (1, ∈, 1, 2.1) (2, ∈, 1, 2.5) (3, ∈, 1, 1.7) (4, ∈, 1, 1.9) |
| | (C, 2), 3.0 | (2, ∈, 0, 2.5) (3, ∈, 1, 2.7) |
| | (A, 1), 0.5 | (4, ∈, 1, 0.1) |
| | (A, 2), 1.0 | (4, ∈, 0, 0.1) |

### CNF Algorithm

Algorithm 12 returns all the satisfying CNF BEs given an assignment. Implementation of the observations below results in an efficient algorithm (Algorithm 12) for finding a CNF c that matches an assignment S:

Observation 1: For a K-index, a necessary (but not sufficient) condition for CNF c (with K disjunctions without ∉ predicates) to match S is that there are at least K posting lists where each list is for a key (A,ν) in S and the ID of c is in the list.

Observation 2: For conjunctions, the analogous property is necessary and sufficient and requires exactly K lists. In the CNF case, a key may now appear in several disjunctions of a CNF and satisfy the expression. This new condition requires two changes: First, the code Step 4 of Algorithm 12 considers all possible K-indexes regardless of |S|. Second, once Algorithm 12 finds a CNF with K matching lists, additional checks must be performed as detailed below.

Algorithm 12: The CNF Algorithm

| 1: | input: inverted list idx and assignment S |
|---|---|
| 2: | output: set of conjunctions IDs O matching S |
| 3: | O ←Ø |
| 4: | for K=idx.MaxConjunctionSize...0 |
| 5: | /* List of posting lists matching A for conjunction size K */ |
| 6: | PLists ← idx.GetPostingLists(S,K) |
| 7: | InitializeCurrentEntries(PLists) |
| 8: | /* Processing K=0 and K=1 are identical */ |
| 9: | if K=0 then K ← 1 |
| 10: | /* Too few posting lists for any conjunction to be satisfied */ |
| 11: | if PLists.size( ) < K then |
| 12: | continue to next for loop iteration |
| 13: | while PLists[K−1].CurrEntry ≠EOL |
| 14: | SortByCurrentEntries(PLists) |
| 15: | /* Check if the first K posting lists have the same |
| conjunction ID in their current entries */ | |
| 16: | PLists[0].CurrEntry.ID = PLists[K−1].CurrEntry.ID |
| | Then |
| 17: | |
| 18: | /* NEW CODE START */ |
| 19: | /* For each disjunction in the current CNF, one counter is |
| initialized to the negative number of ∉ predicates */ | |
| 20: | Counters.Initialize(PLists[0].CurrEntry.ID) |
| 21: | for L = 0...(PLists.size( )−1) do |
| 22: | if PLists[L].CurrEntry.ID = PLists[0].CurrEntry.ID |
| | then |
| 23: | /* Ignore entries in the Z posting list */ |
| 24: | if PLists[L].CurrEntry.DisjID = −1 then |
| 25: | continue to next for loop |
| 26: | if PLists[L].CurrEntry.AnnotatedBy(∉) then |
| 27: | Counters[PLists[L].CurrEntry.DisjID]++ |
| 28: | else /*Disjunction is satisfied*/ |
| 29: | Counters[PLists[L].CurrEntry.DisjID] ← 1 |
| 30: | else |
| 31: | break |
| 32: | Satisfied ←true |
| 33: | for L = 0...Counters.size( )−1 do |
| 34: | /* No ε or ∉ predicates were satisfied */ |
| 35: | if Counters[L] = 0 |
| 36: | Satisfied ←false |
| 37: | if Satisfied = true |
| 38: | O ← O ∪ {PLists[K−1].CurrEntry.ID} |
| 39: | /* NEW CODE END */ |
| 40: | |
| 41: | /* NextID is the smallest possible ID after current ID*/ |
| 42: | NextID ← PLists[K−1].CurrEntry.ID + 1 |
| 43: | else |
| 44: | /* Skip first K−1 posting lists */ |
| 45: | NextID ← PLists[K−1].CurrEntry.ID |
| 46: | for L = 0...K−1 do |
| 47: | /* Skip to smallest ID such that ID ≧ NextID */ |
| 48: | PLists[L].SkipTo(NextID) |
| 49: | return O |

As will be noted, Algorithm 12 is similar to Algorithm 11 in that Steps 3, steps 5-16 and steps 41-49 are identical code. Hence, the following paragraphs elaborate on the differences between Algorithm 11 and Algorithm 12 (i.e. the CNF-related code in Step 4, and Steps 19 through 38), which steps are for checking whether all the disjunctions of a CNF are satisfied. The new CNF code is only invoked for a CNF c where there are at least K posting lists that have c's ID in their current entries (see Step 16). Step 20 initializes an array of integer counters (i.e. the Counters array) where each integer corresponds to a disjunction of c and is initialized to the negative number of ∉ predicates in that disjunction. For instance, if c=(A ∈ {1} [symbol] B ∈ {2}) [symbol] (C ∉ {3} [symbol] D ∈ {4}) [symbol] (E ∉ {5} [symbol] F ∉ {6}), the Counters array is initialized to [0,−1,−2].

At Step 21 it is known that there are K posting lists containing c's ID, but there could actually be more than K. Thus, Step 21 scans and processes all lists in the K-index, looking for ID c. For example, consider a list L, where its current entry contains disjunction ID d. When Algorithm 12 either increases Counters [d] (at Step 27) if the entry has a ∉ annotation, or sets Counters [d] to 1 (at Step 29) if the entry has an ∈ annotation. In Steps 33-36, Algorithm 12 checks if all the disjunctions of c have been satisfied by looking at the counters. A positive counter value means that at least one ∈ predicate has been satisfied for disjunction d, while a negative counter value means that at least one ∉ predicate has been satisfied. Hence, the only case where a disjunction is not satisfied is when the counter value is 0 (i.e. no ∈ predicates have been satisfied and all ∉ predicates, if they exist, have been violated).

### EXAMPLE

Given the assignment S:{A=1,C=2}, the matching posting lists for S from the inverted list of Table 33 are shown in Table 34. The weight coefficients are omitted here in Table 34, and are reintroduced and discussed infra.

TABLE 34
Posting lists for assignment S

| K | Key | Posting List |
|---|---|---|
| 0 | (A, 1) | (6, ∉, 0) |
| | Z | (6, ∈, −1) |
| 1 | (C, 2) | (5, ∉, 1) |
| | (A, 1) | (5, ∈, 0) |
| 2 | (A, 1) | (1, ∈, 0) (2, ∈, 0) (3, ∈, 0) (4, ∈, 0) |
| | (C, 2) | (2, ∈, 0) (3, ∈, 1) |
| | (A, 1) | (4, ∈, 1) |

Since the posting list skipping technique is similar to the skipping techniques of Algorithm 11, the following descriptions focus on the disjunction checking for CNFs. When K=2, the CNFs that are checked in Steps 19 through 38 are c₂, c₃, c₄ (notice that c₁ is skipped because there is only one posting list for c₁). Starting from c₂, Step 20 initializes the Counters array to [0,0] (both disjunctions of c₂ contain no ∉ predicates) and scan posting lists (A,1) and (C,2). Since the entries for c₂ in both posting lists refer to disjunction ID 0, the final state of the Counters is [2,0]. Since the second Counters entry is 0, c₂ is not satisfied. Next, start processing c₃. This time, the two entries for c₃ in posting lists (A,1) and (C,2) refer to disjunction IDs 0 and 1, respectively. As a result, the final state of the Counters is [1,1], and c₃ is added into set O. Finally, c₄ is a case where one key (A,1) satisfies both disjunctions of the CNF. The final state of the Counters is also [1,1] and thus c₄ is added into set O.

The discussion of this example continues with an illustration of handling entries with ∉ annotations when K=1. Since c₅ has two posting lists with entries for c₅, Step 20 starts checking the disjunctions of c₅. Since c₅ has one disjunction with zero ∉ predicates and another with two ∉ predicates, the Counters are initialized to [0,−2]. Then view the current entry of the posting list (A,1) from Step 22 and set Counters [0] to 1 at Step 29. For the next posting list (C,2), increment Counters [1] to −1 at Step 27 because the current entry is annotated by a ∉. The final Counters array is thus [1,−1]. The first disjunction is satisfied because one ∈ predicate is satisfied while the second disjunction is also satisfied because one ∉ predicate is satisfied; thus c₅ is accepted into O.

Algorithm 12 provides for handling of a key “Z” when K=0. Since c₆ has two posting lists with entries for c₆, start checking its disjunctions from Step 20. Since c₆ only has one disjunction with one ∉ predicate, Counters is initialized as [−1]. When viewing the current entry of the posting list (A,1), increment the Counters (to 0). However, Algorithm 12 ignores the next posting list Z. Hence, the final counter is 0, and c₆ is not accepted into O. The final solution O is thus {3,4,5}.

Section VI: Storing the Ranking of Boolean Expressions within an Inverted Index

### DNF Ranking Algorithm

Ranking DNF BEs can be performed based on Algorithm 11 by maintaining a top-N queue of conjunctions and restricting them to have unique DNF IDs within the queue. Since the score of a DNF BE is the maximum score of its conjunction scores, the inverted index needs only to keep the single highest conjunction score for each DNF ID.

Referring to the weights in the inverted list representation of Table 31 to rank BEs, the number next to each posting list key (A,ν) denotes the upper bound weight UB(A,ν). In each posting list entry, the third value denotes the weight w_{c}(A,ν) for conjunction c. For example, the key (age, 4) in Table 31 has a posting list inside the partition K=1 and contains an entry representing c₅ where w_{c}_{₅} (age, 4)=0.5 and UB(age, 4)=3.0. The upper bound for key Z, UB(Z) is defined as 0. In addition, each entry in Z has a weight coefficient of 0.

Algorithm 11 can be extended to efficiently deal with weights by adding the following two pruning techniques:
1. After sorting the posting lists in Step 14, the sum of UB(A,ν)×w_{S}(A,ν) for every posting list PLists[L] such that PLists[L].CurrentEntry.ID≦PLists[K−1].CurrentEntry.ID is an upper bound for the score of the conjunction PLists[K−1]. CurrentEntry.ID. If the upper bound score is less than the Nth highest conjunction score, then skip all the posting lists with CurrentEntry.ID less than or equal to PLists[K−1].CurrentEntry.ID and continue to the next while loop at Step 13.
2. Before processing PLists from Step 7, the sum of the top-K UB(A,ν)×w_{S}(A,ν) values for all the posting lists in PLists is an upper bound of the score for all the matching conjunctions with size K. If the upper bound score is less than the Nth highest conjunction score, then processing of PLists can be skipped for the current K-index and continue to the next for loop at Step 4.

### EXAMPLE

Given the assignment S: {age=3, state=NY, gender=F}, the matching posting lists for K=2 from the inverted lists of Table 31 are shown in Table 35. Notice the assignment weight coefficients in the first column. As shown the weights are w_{S}(state, NY)=1.0, w_{S}(age, 3)=0.8, and w_{S}(gender, F)=0.9. Consider the example of N=1 (i.e. only the conjunction with the single highest score is maintained). The conjunction c₁ is first accepted in Step 28 of Algorithm 11 because two posting lists have current entries for c₁. The score of c₁ is w₁(state,NY)×w_{S}(state,NY)+w₁(age,3)×w_{S}(age,3)=4.0×1.0+0.1×0.8=4.08. The Nth highest score is thus set to 4.08.

TABLE 35
Posting lists for S where K = 2

| wₛ | Key & UB | Posting List |
|---|---|---|
| 1.0 | (state, NY), 5.0 | (1, ∈, 4.0) |
| 0.8 | (age, 3), 1.0 | (1, ∈, 0.1) (2, ∈, 0.1) (3, ∈, 0.2) |
| 0.9 | (gender, F), 2.0 | (2, ∈, 0.3) |

The first pruning technique is illustrated in Table 36 where the posting lists are sorted (Step 14 of Algorithm 11) after accepting c₁. Before checking whether the first and second posting lists have the same conjunction in their current entries (at Step 16), Algorithm 11 computes the upper bound score of c₂ by computing UB(age,3)×w_{S}(age,3)+UB(gender,F)×w_{S}(gender,F)=1.0×0.8+2.0×0.9=2.6. Since 2.6 is smaller than the Nth score 4.08, modified Algorithm 11 immediately skips (i.e. prunes) the first two posting lists to conjunction ID 2+1=3 without invoking Step 16 and continues to the next while loop at Step 13. In this way, pruning is accomplished by comparing a first upper bound score (e.g. the upper bound score of contract c₂) to a second upper bound score (e.g. the upper bound score of the Nth of top N contracts).

TABLE 36
Sorted posting lists after accepting c₁

| wₛ | Key & UB | Posting List |
|---|---|---|
| 0.8 | (age, 3), 1.0 | (1, ∈, 0.1) (2, ∈, 0.1)(3, ∈, 0.2) |
| 0.9 | (gender, F), 2.0 | (2, ∈, 0.3) |
| 1.0 | (state, NY), 5.0 | (1, ∈, 4.0) EOL |

The second pruning technique is illustrated in Table 37, which shows the posting lists for K=1. Before processing the posting lists from Step 6 of Algorithm 11, first derive the upper bound score for all the conjunctions in the K-index by computing UB(age,3)×w_{S}(age,3)=1.0×0.7=0.7. Since an upper bound score of 0.7 is less than the current Nth score 4.08, skip processing (i.e. prune) the posting lists for K=1. Similarly, K=0 (not shown) can also be skipped to return the final solution c₁, which has the highest score 4.08.

TABLE 37
Posting lists for S where K = 1

| wₛ | Key & UB | Posting List |
|---|---|---|
| 0.7 | (age, 3), 1.0 | (5, ∈, 0.1) |

### CNF Ranking Algorithm

Ranking CNF BEs can be done with the CNF algorithm (Algorithm 12) by maintaining a top-N queue of CNF BEs. In fact, the first pruning technique of the DNF ranking algorithm can be applied in the CNF algorithm 12. Since the score of a CNF BE is the sum of the disjunction scores while the score of a disjunction is the maximum score of its predicates, the sum UB(A,ν)×w_{S}(A,ν) for every posting list PLists[L] where PLists[L].CurrentEntry.ID≦PLists[K−1].CurrentEntry.ID is still an upper bound for the score of the CNF of PLists[K−1].CurrentEntry.ID.

However, the technique of computing the upper bound score as discussed in the DNF ranking algorithm does not apply directly to the CNF ranking algorithm because more than K disjunctions may contribute to the score of a CNF with size K (i.e. disjunctions that contain both ∈ and ∉ predicates do not count in the size of the CNF, but such predicates may have scores that add to the CNF score). Hence, the sum of the top-K UB(A,ν)×w_{S}(A,ν) values in PLists is not an upper bound score of a CNF BE. The upper bound score of a CNF BE is calculated as the sum of the disjunction scores.

### EXAMPLE

Given the assignment S: {A=1, C=2}, the matching posting lists for K=2 from the inverted list of Table 34 are shown in Table 38 along with the given assignment weight coefficients w_{S}(A,1)=0.1 and w_{S}(C,2)=0.9. As earlier discussed, the only matching CNFs in Table 38 are c₃ and c₄. In this example, after accepting c₃ and deriving the score w₃(A,1)×w_{S}(A,1)+w₃(C,2)×w_{S}(C,2)=0.3×0.1+2.7×0.9=2.46, this pruning technique skips processing CNF ID 4 from Step 16 because the upper bound of c₄ is UB(A,1)×w_{S}(A,1)+UB(A,1)×w_{S}(A,1)=0.5×0.1+0.5×0.1=0.1, which is smaller than 2.46.

TABLE 38
Posting lists for S where K = 2

| wₛ | Key & UB | Posting List |
|---|---|---|
| 0.1 | (A, 1), 0.5 | (1, ∈, 0, 0.1) (2, ∈, 0, 0.3) (3, ∈, 0, 0.3) (4, ∈, 0, 0.1) |
| 0.9 | (C, 2), 3.0 | (2, ∈, 0, 2.5) (3, ∈, 1, 2.7) |
| 0.1 | (A, 1), 0.5 | (4, ∈, 1, 0.1) |

### Section VII: Detailed Description of Exemplary Embodiments

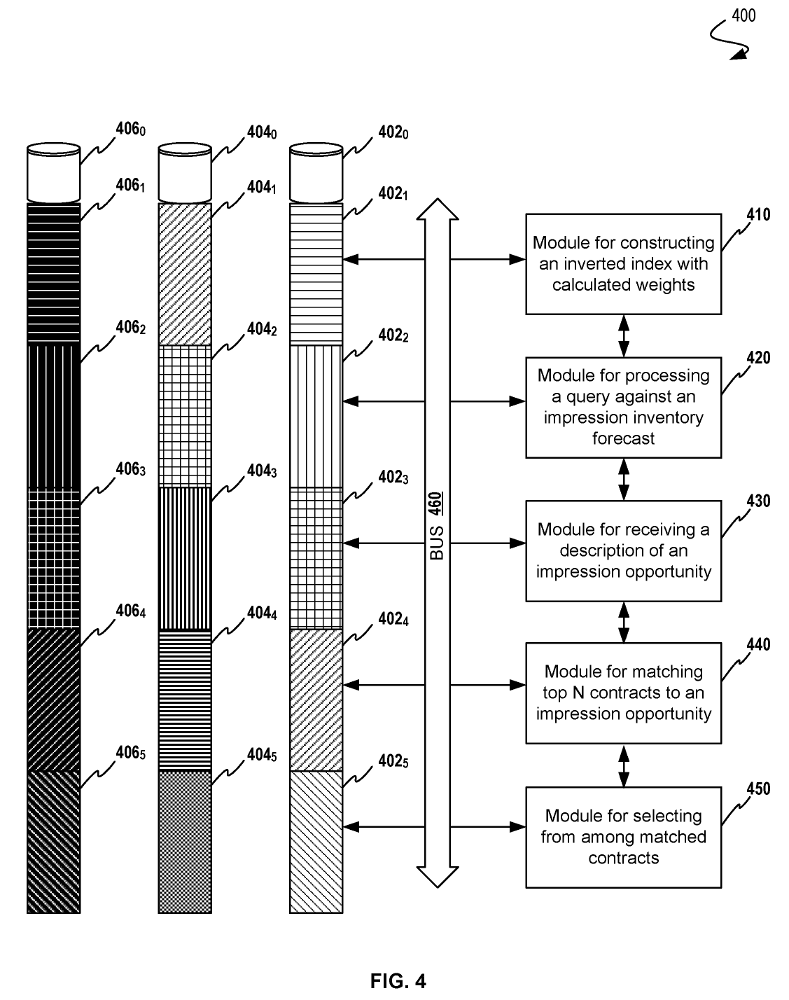

FIG. 4 is a flowchart of a system for automatic matching of the top N highest scoring contracts to impression opportunities using complex predicates and an inverted index, according to one embodiment. As an option, the present system 400 may be implemented in the context of the architecture and functionality of FIG. 1A through FIG. 3. In particular, system 400 might be included in embodiments of system 300. Of course, however, the system 400 or any operation therein may be carried out in any desired environment. As shown, any of the modules 410, 420, 430, 440, 450 are configured to retrieve and store data from/to one or more databases 402₀, 404₀, 406₀ via a bus 460. Moreover, any operation performed by any of the modules 410, 420, 430, 440, 450 might retrieve data in a particular format (e.g. 402₁, 402₂, 402₃, etc), and/or store data during or after any operation into a particular format (e.g. 402₁, 402₂, 402₃, etc). As shown, any of the modules 410, 420, 430, 440, 450 are configured to communicate to or through its neighbors via inter-module signaling, or via changes to a database. In fact, operations within one module might execute before, after, or concurrent with any operations in any other module. In an exemplary practice, the module for constructing an inverted index with calculated weights 410 might conclude its operations at least once before any operations of modules 420, 430, 440, or 450 begin. Once an inverted index with calculated weights is available, operations for matching of contracts to impression opportunities might commence. In somewhat formal terms, an exemplary embodiment might be described as: Module 410 is for constructing an inverted index wherein a first set of contracts are sorted, and wherein each contract includes at least one first weighted predicate; module 420 is for processing a query against an impression inventory forecast; module 430 is for receiving a description of an impression opportunity, wherein each impression opportunity profile includes at least one second weighted predicate; module 440 is for creating a match set to an impression opportunity containing only the top N weighted matches from among the first set of weighted contracts, wherein a match operation includes matching at least one first weighted predicate to at least one second weighted predicate; and module 450 is for selecting from the match set of the top N matching weighted contracts for delivery of at least one impression.

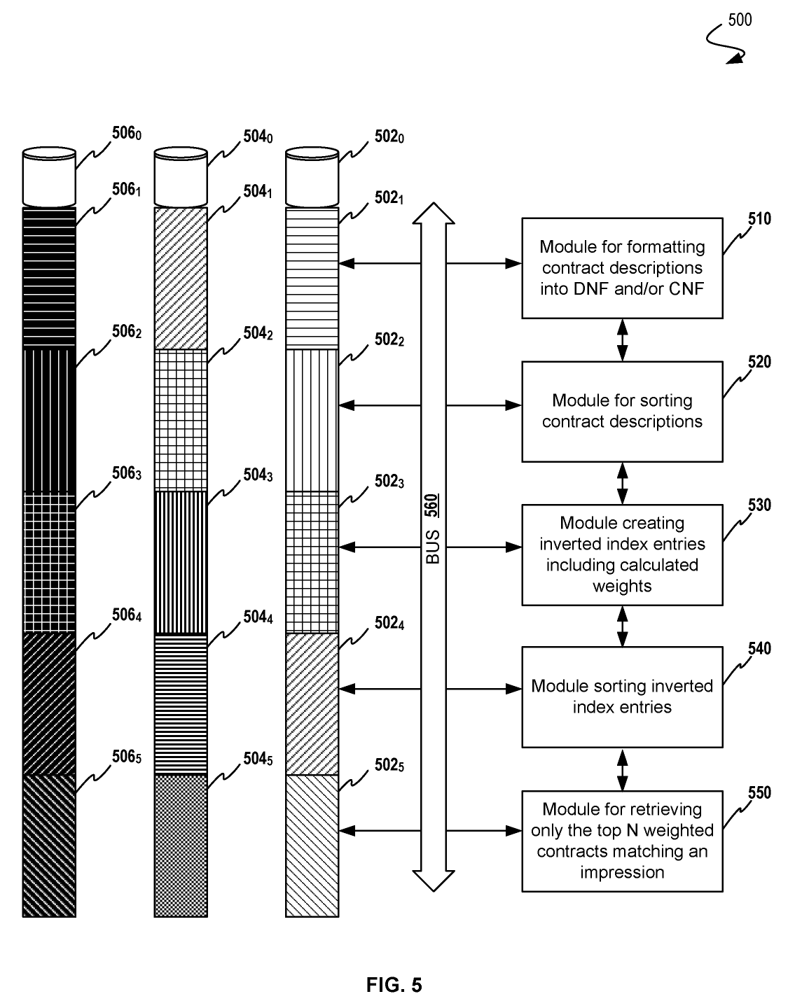

FIG. 5 is a flowchart of a system for automatic matching of the top N highest scoring contracts to impression opportunities using complex predicates and an inverted index, according to one embodiment. As an option, the present system 500 may be implemented in the context of the architecture and functionality of FIG. 1A through FIG. 4. In particular, system 500 might be included in embodiments of modules 410, or 420. Of course, however, the system 500 or any operation therein may be carried out in any desired environment. Any of the modules 510, 520, 530, 540, 550 may communicate with other modules or with the databases as described above pertaining to FIG. 4, and further may communicate freely to any supervisor or any subordinate system. In somewhat formal terms, an exemplary embodiment might be described as: Module 510 is for formatting contract descriptions into either disjunctive normal form representation or conjunctive normal form representation; module 520 is for sorting the first set of contract descriptions including sorting by at least one of a contract ID or a number of predicates in each contract; module 530 is for creating a plurality of inverted index entries wherein each inverted index entry includes at least one weight, and includes a posting list in sorted order; module 540 is for sorting at least two inverted index entries (e.g. sorting a contract size sorting key, sorting by a predicate sorting key, etc); and module 550 is for retrieving only the top N from among a set of contracts matching an impression opportunity profile. Of course any of the data structures created or modified by system 500 may use any or all or none of the techniques described in the foregoing.

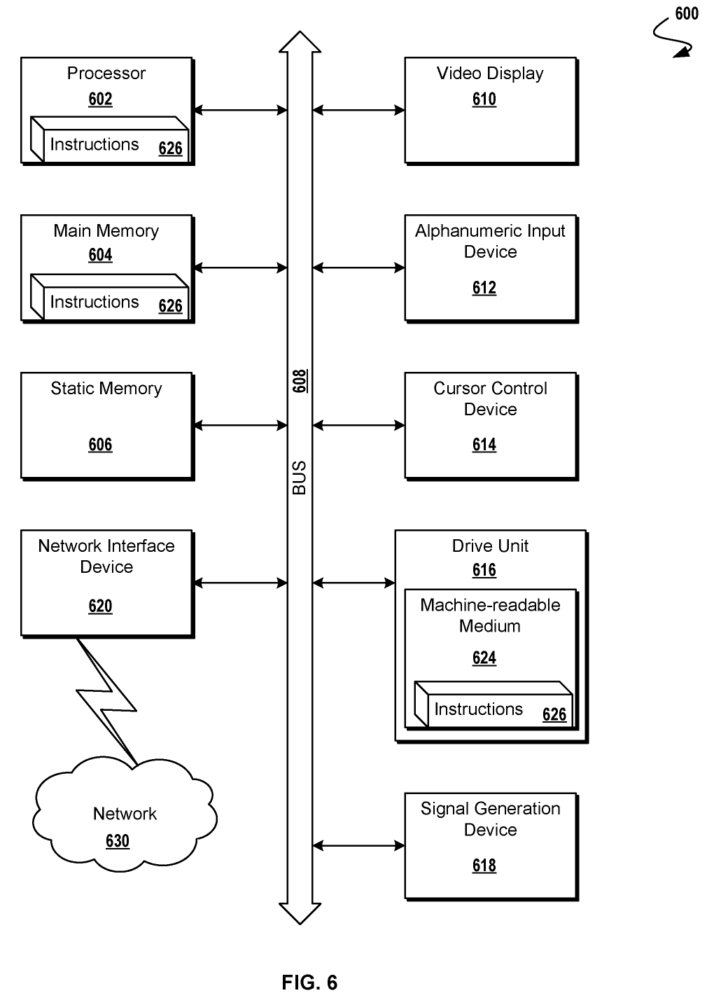

FIG. 6 shows a diagrammatic representation of a machine in the exemplary form of a computer system 600 within which a set of instructions for causing the machine to perform any one of the methodologies discussed above may be executed. The embodiment shown is purely exemplary, and might be implemented in the context of one or more of FIG. 1A through FIG. 5. In alternative embodiments, the machine may comprise a network router, a network switch, a network bridge, a Personal Digital Assistant (PDA), a cellular telephone, a web appliance, or any machine capable of executing a sequence of instructions that specify actions to be taken by that machine.

The computer system 600 includes a processor 602, a main memory 604 and a static memory 606, which communicate with each other via a bus 608. The computer system 600 may further include a video display unit 610 (e.g. a liquid crystal display (LCD) or a cathode ray tube (CRT)). The computer system 600 also includes an alphanumeric input device 612 (e.g. a keyboard), a cursor control device 614 (e.g. a mouse), a disk drive unit 616, a signal generation device 618 (e.g. a speaker), and a network interface device 620.

The disk drive unit 616 includes a machine-readable medium 624 on which is stored a set of instructions (i.e. software) 626 embodying any one, or all, of the methodologies described above. The software 626 is also shown to reside, completely or at least partially, within the main memory 604 and/or within the processor 602. The software 626 may further be transmitted or received via the network interface device 620 over the network 630.

It is to be understood that embodiments of this invention may be used as, or to support, software programs executed upon some form of processing core (such as the CPU of a computer) or otherwise implemented or realized upon or within a machine- or computer-readable medium. A machine-readable medium includes any mechanism for storing or transmitting information in a form readable by a machine (e.g. a computer). For example, a machine-readable medium includes read-only memory (ROM); random access memory (RAM); magnetic disk storage media; optical storage media; flash memory devices; electrical, optical, acoustical or other form of propagated signals (e.g. carrier waves, infrared signals, digital signals, etc); or any other type of media suitable for storing or transmitting information.

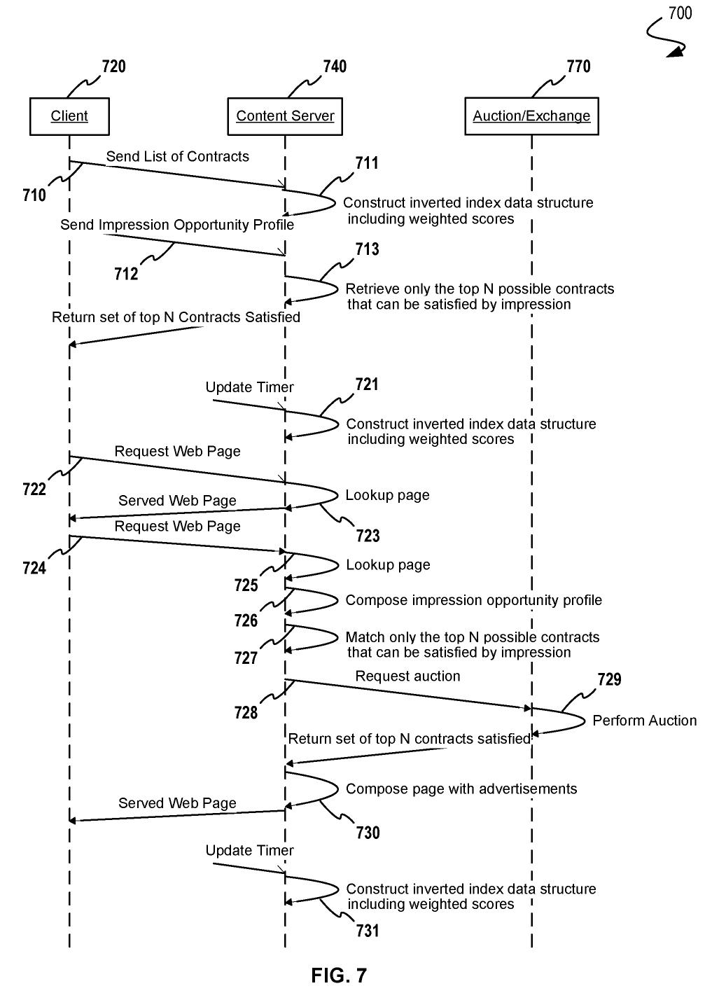

FIG. 7 is a diagrammatic representation of several computer systems (i.e. a client server 720, a content server 740, and an auction/exchange server 770) in the exemplary form of a client server network 700 within which environment a communication protocol may be executed. The embodiment shown is purely exemplary, and might be implemented in the context of one or more of FIG. 1A through FIG. 6. As shown the content server 740 is operable for receiving a list of contracts 710, each contract containing at least one target predicate in CNF form having a plurality of conjuncts, or in DNF form having a plurality of terms, or in the form of an arbitrarily complex Boolean expression with any number of conjuncts and/or disjuncts; preparing a data structure index including weighted scores of the set of contracts 711; receiving at least one web page profile predicate 712; and retrieving from the data structure only the top N contracts wherein at least one target predicate matches at least one web page description predicate 713. Additionally, and as shown in this embodiment, the content server 740 is capable of autonomously and asynchronously constructing an inverted index including weighted scores (see operations 721 and 731). The client 720 is capable of initiating a communication protocol by requesting a web page lookup 722. Such a request might be satisfied solely by a content server 740 by the lookup page operation 723, or it might be satisfied by a content server 740 and any number of additional auction or exchange servers 770 acting in concert. In general, and as shown in the exemplary embodiment, any server or client for that matter might be capable of performing any or all of the operations 410 through 450 (and/or performing any or all of the operations 510 through 550), and/or sending data to any database 402₀, 404₀, 406₀ (and/or sending data to any database 502₀, 504₀, 506₀), etc which might be located on any server. Strictly for illustrative purposes, any server or client might be configured to perform any one or more operations involved in a method for automatic matching highest scoring contracts to impression opportunities using complex predicates and an inverted index. The operations might start from a client requesting a web page 724, and proceed with operations corresponding to a page lookup 725, composing an impression opportunity profile 726, matching only the top N possible contracts to the impression opportunity profile 727, requesting an auction 728 and performing an auction 729, composing the impression including advertisements corresponding to the winning bids 730 and serving the composited page as a web page impression rendered at the client terminal 720.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

We claim:

1. A method for indexing weighted advertising contracts for matching to a weighted web page profile comprising:
receiving a set of contracts, each contract containing at least one of, a target predicate in CNF form having a plurality of conjuncts, a target predicate in DNF form having a plurality of terms;
preparing a data structure index of the set of contracts;
receiving at least one said weighted web page profile predicate; and
retrieving from the data structure only the top N weighted contracts wherein at least one target predicate matches at least one said weighted web page profile predicate.

2. The method of claim 1, further comprising:
constructing an inverted index wherein a first set of contracts are sorted, wherein each contract includes at least one first predicate, wherein each first predicate is associated with a weight;
receiving an impression opportunity profile, wherein each impression opportunity profile includes at least one second predicate, wherein each second predicate is associated with a weight;
creating a match set containing only the top N weighted contracts from among the first set of contracts, wherein a match operation includes matching at least one first predicate to at least one second predicate; and
presenting the match set for delivery of at least one impression.

3. The method of claim 2, wherein the constructing includes an upper bound weight corresponding to a Boolean expression comprising at least one predicate.

4. The method of claim 2, wherein the constructing includes a weighting coefficient corresponding to at least one predicate.

5. The method of claim 2, wherein the constructing includes making posting lists of contracts for each IN predicate.

6. The method of claim 5, wherein the posting lists are sorted by a contract id.

7. The method of claim 5, wherein the posting lists include at least one attribute name and single value pair of an IN predicate.

8. The method of claim 2, wherein the contract includes a description containing at least one of, disjunctive normal form representation, conjunctive normal form representation.

9. The method of claim 2, wherein the at least one first predicate is decomposed from a multiple-predicate conjunctive expression.

10. The method of claim 9, wherein the multiple-predicate conjunctive expression includes at least one NOT-IN predicate.

11. The method of claim 2, wherein the at least one first predicate is decomposed from a multiple-predicate disjunctive expression.

12. The method of claim 2, wherein the impression opportunity profile is specified as a vector of feature-value pairs.

13. The method of claim 2, wherein the impression opportunity profile includes a description containing at least one of, disjunctive normal form representation, conjunctive normal form representation.

14. The method of claim 2, wherein creating a match set containing only the top N weighted contracts includes pruning by comparing a first upper bound score of a first predicate to second upper bound score.

15. The method of claim 2, wherein creating a match set containing only the top N weighted contracts includes pruning by comparing a first upper bound score of a first predicate to an second upper bound score of a predicate size partition score.

16. The method of claim 2, wherein the match operation prunes contracts containing any NOT-IN predicates violated by the impression opportunity profile.

17. The method of claim 2, wherein constructing further comprises:
formatting contract descriptions into at least one of disjunctive normal form representation, conjunctive normal form representation;
sorting the first set of contracts includes sorting by at least one of, contract ID, number of predicates in each contract;
creating a plurality of inverted index entries wherein each inverted index entry includes a posting list in sorted order;
sorting at least two inverted index entries.

18. The method of claim 17, wherein sorting at least two inverted index entries includes sorting by at least a contract size sorting key and a predicate sorting key.

19. The method of claim 17, wherein creating a plurality of inverted index entries includes duplicates of the posting list as many as the maximum number of distinct conjunct IDs among the first set of contracts

20. An apparatus for indexing weighted advertising contracts for matching to a weighted web page profile comprising:
a module for receiving a set of contracts, each contract containing at least one of, a target predicate in CNF form having a plurality of conjuncts, a target predicate in DNF form having a plurality of terms;
a module for preparing a data structure index of the set of contracts;
a module for receiving at least one said weighted web page profile predicate; and
a module for retrieving from the data structure only the top N weighted contracts wherein at least one target predicate matches at least one said weighted web page profile predicate.
